(19) United States
(12) Patent Application Publication
(10) Pub. No.: US 2014/0141362 A1
(43) Pub. Date: May 22, 2014

(54) ELECTROPHOTOGRAPHIC PHOTOSENSITIVE MEMBER, PROCESS CARTRIDGE AND ELECTROPHOTOGRAPHIC APPARATUS

(71) Applicant: CANON KABUSHIKI KAISHA, Tokyo (JP)

(72) Inventors: Kaname Watariguchi, Mishima-shi (JP); Masato Tanaka, Tagata-gun (JP); Masataka Kawahara, Mishima-shi (JP); Akira Yoshida, Yokohama-shi (JP)

(73) Assignee: CANON KABUSHIKI KAISHA, Tokyo (JP)

(21) Appl. No.: 14/078,500

(22) Filed: Nov. 12, 2013

(30) Foreign Application Priority Data
Nov. 20, 2012 (JP) 2012-254339
Oct. 24, 2013 (JP) 2013-221107

(51) Int. Cl. G03G 15/00; G03G 21/18

(52) U.S. Cl. CPC G03G 5/142; G03G 21/18
USPC 430/56; 399/111; 430/64; 399/159

(57) ABSTRACT

An electrophotographic photosensitive member includes a support, an undercoat layer formed on the support, and a photosensitive layer which is formed on the undercoat layer and contains a charge generating substance and a hole transporting substance. The undercoat layer contains a specific amine compound, titanium oxide crystal particles having an average primary particle diameter of 3 nm or more and 15 nm or less and an organic resin.

### BACKGROUND OF THE INVENTION

1. Field of the Invention

The present invention relates to an electrophotographic photosensitive member, and a process cartridge and an electrophotographic apparatus each having an electrophotographic photosensitive member.

2. Description of the Related Art

In a recent electrophotographic apparatus such as a copy machine and a laser beam printer, an electrophotographic photosensitive member (organic electrophotographic photosensitive member) having a photosensitive layer containing a charge generating substance and a hole transporting substance (charge transporting substance) on a support is widely used.

In order to improve the adhesion between a support and a photosensitive layer, to protect a photosensitive layer from electrical damage, and to inhibit the hole injection from a support to a photosensitive layer, an undercoat layer is disposed between a support and a photosensitive layer in many cases. Such an undercoat layer having the advantages described above, however, has a disadvantage that charges are easily accumulated therein. An electrophotographic photosensitive member having an undercoat layer, therefore, easily causes a phenomenon called ghosting. More specifically, positive ghosting which generates a deep concentration only at a portion irradiated with light during a prior rotation and negative ghosting which generates a thin concentration only at a portion irradiated with light during a prior rotation are observed in an outputted image.

Examples of known charge generating substances having high sensitivity include a phthalocyanine pigment and an azo pigment.

An electrophotographic photosensitive member using a phthalocyanine pigment or an azo pigment, however, easily causes accumulation of electrons as pairs of holes moved with a hole transporting substance in a photosensitive layer (charge generating layer) due to the large amount of generated photo carriers (holes and electrons). An electrophotographic photosensitive member using a phthalocyanine pigment or an azo pigment, therefore, also easily causes ghosting.

International Publication No. WO2009/072637 discloses that anatase titanium oxide crystal particles having an average primary particle diameter of 3 nm or more and 9 nm or less contained in an undercoat layer disposed between a support and a photosensitive layer reduce the variation in exposure potential for repeated image formation for a long period.

Japanese Patent Application Laid-Open No. 2002-091044 discloses that an electron transporting organic compound and a polyamide resin contained in an undercoat layer disposed between a support and a photosensitive layer reduce environmental variations in exposure potential and residual potential.

Japanese Patent Application Laid-Open No. 2007-148293 discloses that an electron transporting substance contained in a charge generating layer and an intermediate layer disposed between a support and a charge generating layer reduces ghosting.

Japanese Patent Application Laid-Open No. H08-095278 discloses that a benzophenone derivative contained in a photosensitive layer improves gas resistance and prevents desensitization and reduction in electrification property.

Japanese Patent Application Laid-Open No. S58-017450 discloses that a benzophenone derivative contained in a layer disposed between a support and a photosensitive layer prevents desensitization after repeated use.

It is currently desired to reduce ghosting in various environments, in particular, in a low temperature and low humidity environment. However, according to the investigation by the present inventors, the conventional arts have insufficient effect on reducing ghosting under a low temperature and low humidity environment in some cases.

### SUMMARY OF THE INVENTION

The present invention is directed to providing an electrophotographic photosensitive member which reduces ghosting even under a low temperature and low humidity environment, and a process cartridge and an electrophotographic apparatus each having the electrophotographic photosensitive member.

An electrophotographic photosensitive member comprising: a support; an undercoat layer formed on the support; and a photosensitive layer formed on the undercoat layer; wherein: the photosensitive layer includes a charge generating substance and a hole transporting substance, and the undercoat layer includes: an amine compound represented by the following formula (1); titanium oxide crystal particles having an average primary particle diameter of 3 nm or more and 15 nm or less; and an organic resin;

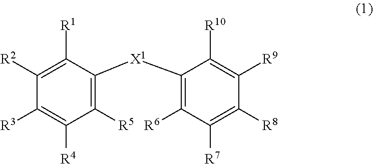

where, R¹ to R¹⁰ each independently represent a hydrogen atom, a halogen atom, a hydroxy group, a carboxyl group, an alkoxycarbonyl group, an aryloxycarbonyl group, a substituted or unsubstituted acyl group, a substituted or unsubstituted alkyl group, a substituted or unsubstituted alkoxy group, a substituted or unsubstituted aryloxy group, a substituted or unsubstituted amino group, or a substituted or unsubstituted cyclic amino group; at least one of R¹ to R¹⁰ is an amino group substituted with a substituted or unsubstituted aryl group, an amino group substituted with a substituted or unsubstituted alkyl group, or a substituted or unsubstituted cyclic amino group; X¹ represents one of a carbonyl group or a dicarbonyl group.

Further, the present invention is directed to providing a process cartridge which integrally supports the electrophotographic photosensitive member and at least one unit selected from the group consisting of an electrification unit, a development unit, a transfer unit and a cleaning unit, and is detachable to an electrophotographic apparatus body.

Further, the present invention is directed to providing an electrophotographic apparatus having the electrophotographic photosensitive member, an electrification unit, an image exposure unit, a development unit and a transfer unit.

The present invention is directed to providing an electrophotographic photosensitive member which reduces ghosting even under a low temperature and low humidity environment, and provide a process cartridge and an electrophotographic apparatus each having the electrophotographic photosensitive member.

Further features of the present invention will become apparent from the following description of exemplary embodiments with reference to the attached drawings.

### BRIEF DESCRIPTION OF THE DRAWINGS

FIG. 1 is a schematic view of an electrophotographic photosensitive member.

FIG. 2 is a schematic view of an electrophotographic apparatus provided with a process cartridge having an electrophotographic photosensitive member.

FIG. 3 illustrates an image for evaluating ghosting.

### DESCRIPTION OF THE EMBODIMENTS

Preferred embodiments of the present invention will now be described in detail in accordance with the accompanying drawings.

The present invention relates to an electrophotographic photosensitive member including a support, an undercoat layer formed on the support (also referred to as an intermediate layer or a barrier layer), and a photosensitive layer formed on the undercoat layer, wherein the photosensitive layer includes a charge generating substance and a hole transporting substance. The undercoat layer includes an amine compound represented by the following formula (1), titanium oxide crystal particles having an average primary particle diameter of 3 nm or more and 15 nm or less, and an organic resin.

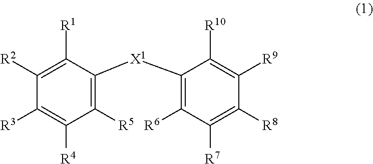

In the formula (1), R¹ to R¹⁰ each independently represent a hydrogen atom, a halogen atom, a hydroxy group, a carboxyl group, an alkoxycarbonyl group, an aryloxycarbonyl group, a substituted or unsubstituted acyl group, a substituted or unsubstituted alkyl group, a substituted or unsubstituted alkoxy group, a substituted or unsubstituted aryloxy group, a substituted or unsubstituted amino group, or a substituted or unsubstituted cyclic amino group. At least one of R¹ to R¹⁰ is an amino group substituted with a substituted or unsubstituted aryl group, an amino group substituted with a substituted or unsubstituted alkyl group, or a substituted or unsubstituted cyclic amino group. X¹ represents one of a carbonyl group or a dicarbonyl group.

The average primary particle diameter of titanium oxide crystal particles (particles of titanium oxide crystal) may be referred to as “average crystallite diameter”.

At least one of R¹ to R¹⁰ of the amine compound represented by the formula (1) can be an amino group substituted with a substituted or unsubstituted alkyl group.

The amino group substituted with a substituted or unsubstituted alkyl group can be a dialkylamino group. The dialkylamino group can be a dimethylamino group or a diethylamino group.

At least one of R¹ to R¹⁰ of the amine compound represented by the formula (1) can be preferably a substituted or unsubstituted cyclic amino group. The cyclic amino group means the cyclic amino group having 3 to 8-membered rings, and at least one carbon atom forming rings may be replaced with an oxygen atom, nitrogen atom and so on.

The substituted or unsubstituted cyclic amino group can be more preferably a morpholino group or a 1-piperidyl group.

Examples of the substituent group which each of the substituted or unsubstituted acyl group, the substituted or unsubstituted alkyl group, the substituted or unsubstituted alkoxy group, the substituted or unsubstituted aryloxy group, the substituted or unsubstituted amino group, the substituted or unsubstituted aryl group, and the substituted or unsubstituted cyclic amino group in the formula (1) may have include an alkyl group such as a methyl group, an ethyl group, a propyl group and a butyl group, an alkoxy group such as a methoxy group and an ethoxy group, a dialkylamino group such as a dimethylamino group and a diethylamino group, an alkoxycarbonyl group such as a methoxycarbonyl group and an ethoxycarbonyl group, an aryl group such as a phenyl group, a naphthyl group and a biphenylyl group, a halogen atom such as a fluorine atom, a chlorine atom and a bromine atom, a hydroxy group, a nitro group, a cyano group and a halomethyl group. In particular, an aryl group and an alkoxy group can be suitable for use.

Examples of the titanium oxide crystal particles having an average primary particle diameter of 3 nm or more and 15 nm or less contained in the undercoat layer can include rutile-type titanium oxide crystal particles including tin atoms. In the rutile-type titanium oxide crystal particles including tin atoms, part of the titanium atoms in the titanium oxide is replaced with the tin atoms.

The present inventors expect that the electrophotographic photosensitive member of the present invention has an excellent effect on reducing ghosting due to the following reasons.

The amine compound represented by the formula (1) has a benzophenone skeleton as a fundamental skeleton. The amine compound further includes at least one of an amino group substituted with a substituted or unsubstituted aryl group, an amino group substituted with a substituted or unsubstituted alkyl group and a substituted or unsubstituted cyclic amino group. Since the amine compound includes a substituent group (a substituted or unsubstituted aryl group or a substituted or unsubstituted alkyl group) through an amino group, or an amino group has a cyclic structure, it is believed that the spatial extent of electronic orbit of the benzophenone skeleton as the fundamental skeleton is distorted to have a good effect on the accumulation properties of charges. It is believed that the larger dipole moment of the benzophenone skeleton as a fundamental skeleton than that of, for example, an anthraquinone skeleton also has an advantageous effect on reducing ghosting.

It is believed that the amine compound represented by the formula (1) having such properties has a further advantageous effect on reducing ghosting when contained in an undercoat layer together with titanium oxide crystal particles of fine size. The reason is that the intrinsic characteristics of the undercoat layer which contains titanium oxide crystal particles of fine size to improve charge accumulation properties without reducing electrification property can be synergistically improved with the amine compound. It is believed that the presence of the amine compound on the surface of the titanium oxide crystal particles and at the interface between an undercoat layer and a photosensitive layer allows electrons generated in the photosensitive layer (charge generating layer) to easily move to the titanium oxide crystal particles contained in the undercoat layer, so that the accumulation properties can be improved. Since the titanium oxide crystal particles of fine size as in the present invention have a large specific surface, the effect of addition of the amine compound is especially significant.

Although specific examples (example compounds) of the suitable amine compound represented by the formula (1) are described below, the present invention is not limited thereto.

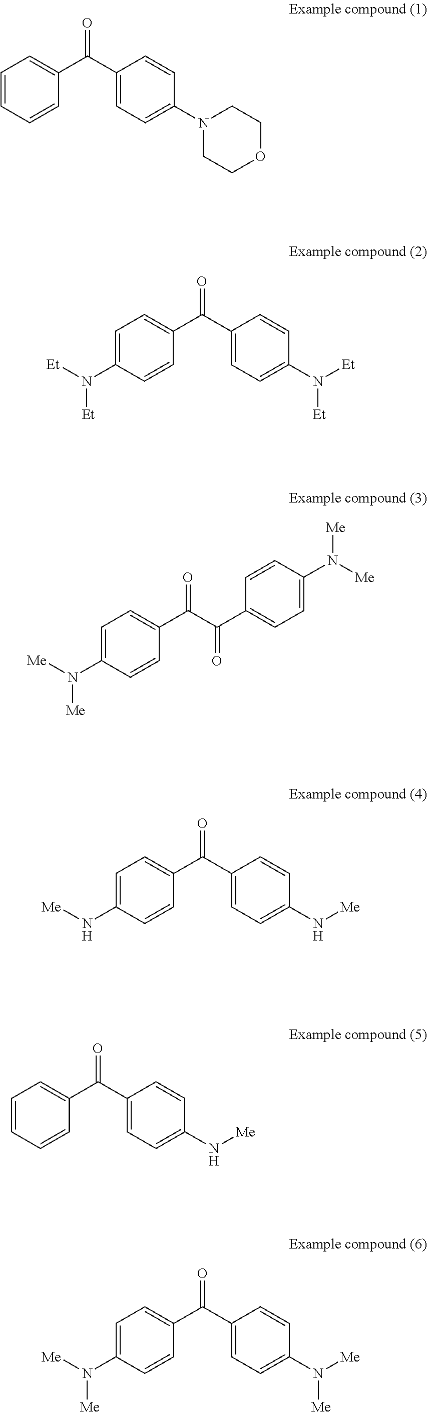 [SMILES: O=C(c1ccccc1)c1ccc(N2CCOCC2)cc1 ; CCN(CC)c1ccc(C(=O)c2ccc(N(CC)CC)cc2)cc1 ; CN(C)c1ccc(C(=O)C(=O)c2ccc(N(C)C)cc2)cc1 ; CNc1ccc(C(=O)c2ccc(NC)cc2)cc1 ; CNc1ccc(C(=O)c2ccccc2)cc1 ; CN(C)c1ccc(C(=O)c2ccc(N(C)C)cc2)cc1]

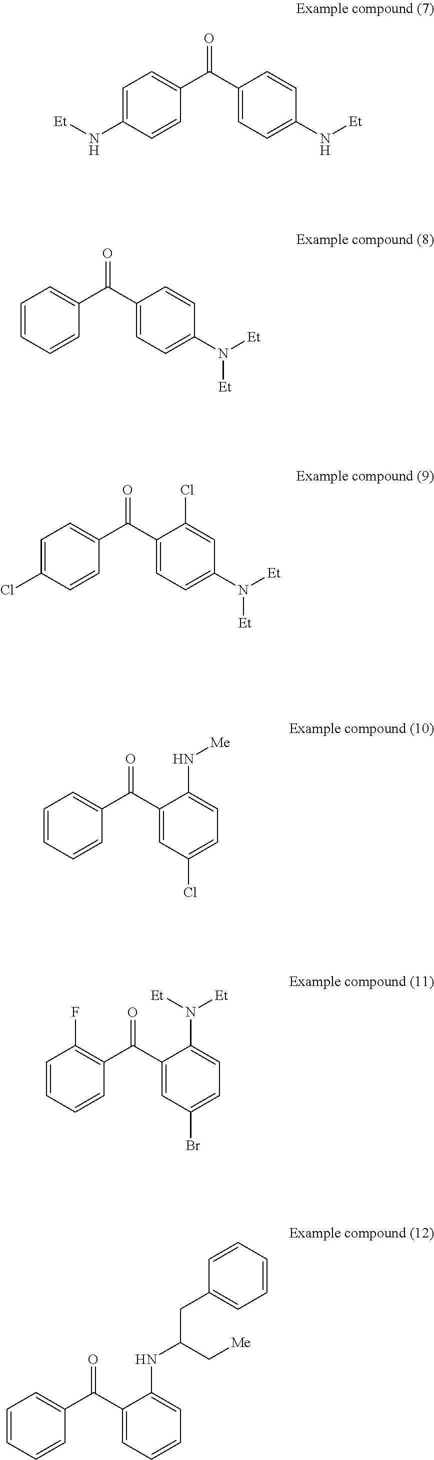 [SMILES: CCNc1ccc(C(=O)c2ccc(NCC)cc2)cc1 ; CCN(CC)c1ccc(C(=O)c2ccccc2)cc1 ; CCN(CC)c1ccc(C(=O)c2ccc(Cl)cc2)c(Cl)c1 ; CNc1ccc(Cl)cc1C(=O)c1ccccc1 ; CCN(CC)c1ccc(Br)cc1C(=O)c1ccccc1F ; CCC(Cc1ccccc1)Nc1ccccc1C(=O)c1ccccc1]

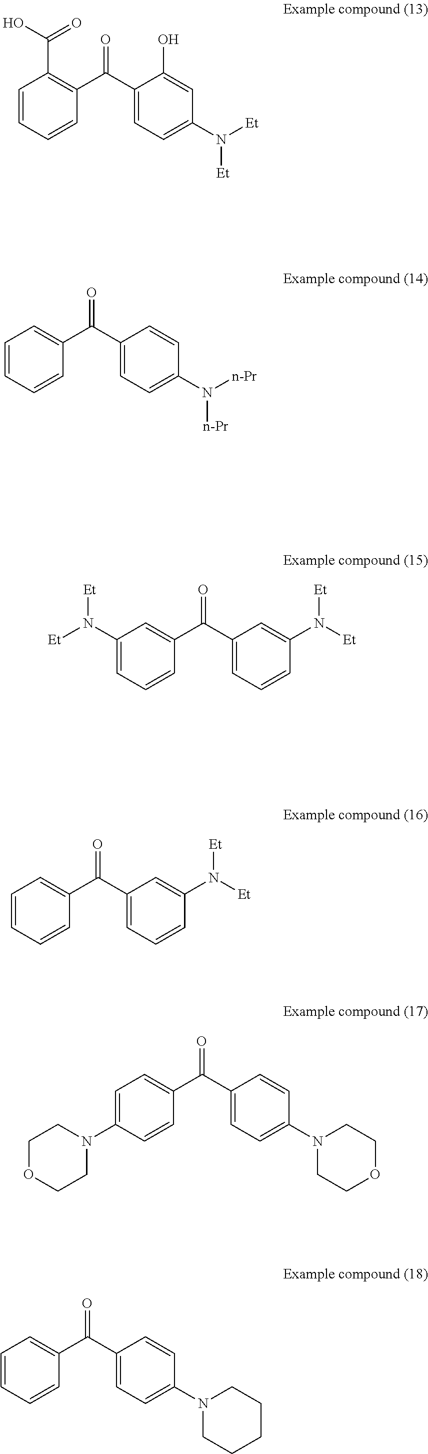

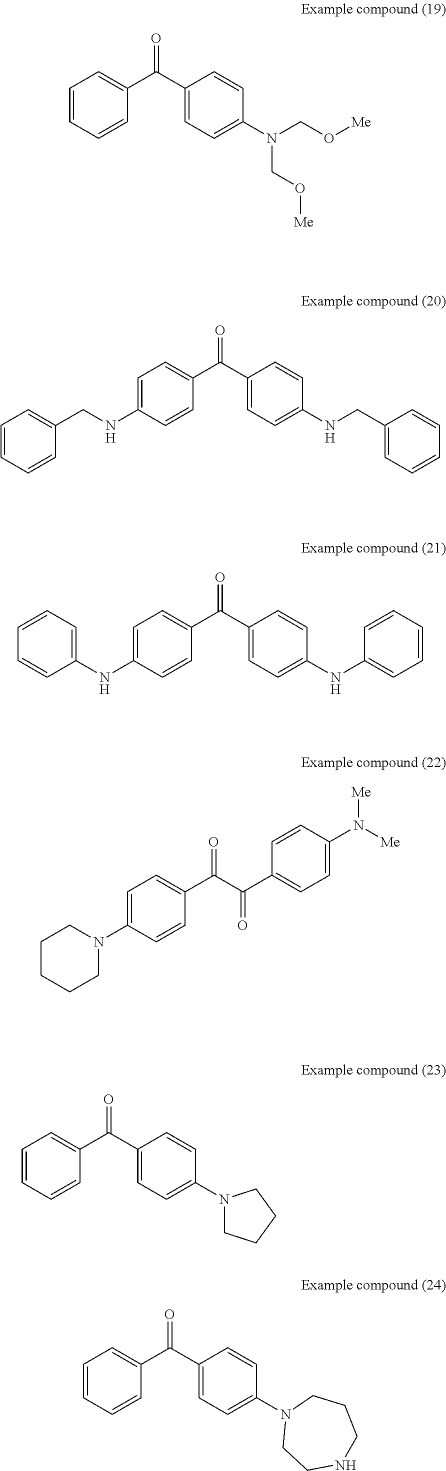 [SMILES: COCN(COC)c1ccc(C(=O)c2ccccc2)cc1 ; O=C(c1ccc(NCc2ccccc2)cc1)c1ccc(NCc2ccccc2)cc1 ; O=C(c1ccc(Nc2ccccc2)cc1)c1ccc(Nc2ccccc2)cc1 ; CN(C)c1ccc(C(=O)C(=O)c2ccc(N3CCCCC3)cc2)cc1 ; O=C(c1ccccc1)c1ccc(N2CCCC2)cc1 ; O=C(c1ccccc1)c1ccc(N2CCCNCC2)cc1]

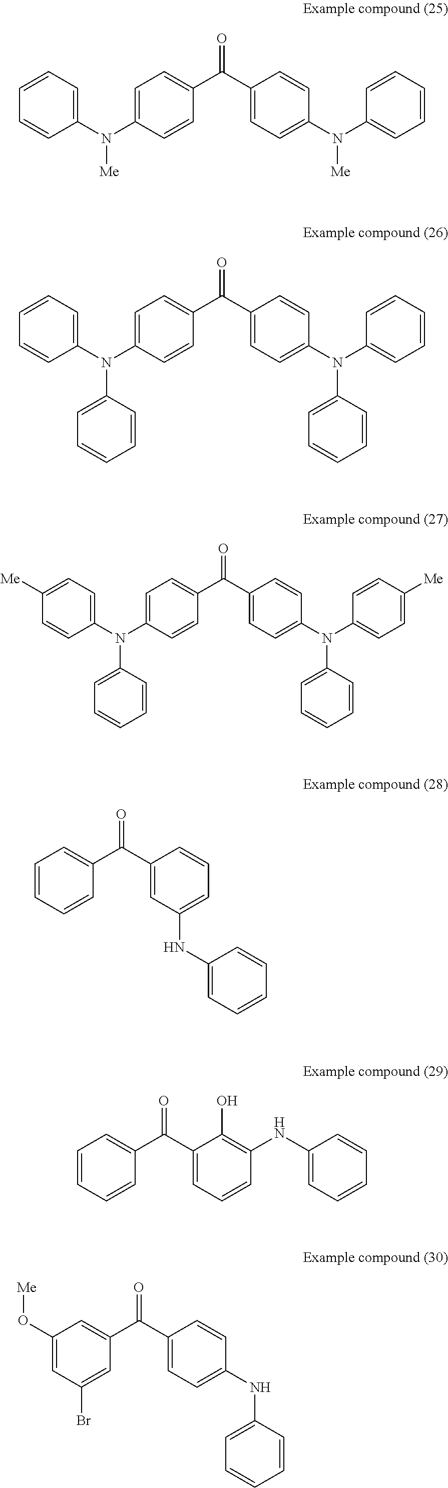 [SMILES: CN(c1ccccc1)c1ccc(C(=O)c2ccc(N(C)c3ccccc3)cc2)cc1 ; O=C(c1ccc(N(c2ccccc2)c2ccccc2)cc1)c1ccc(N(c2ccccc2)c2ccccc2)cc1 ; Cc1ccc(N(c2ccccc2)c2ccc(C(=O)c3ccc(N(c4ccccc4)c4ccc(C)cc4)cc3)cc2)cc1 ; O=C(c1ccccc1)c1cccc(Nc2ccccc2)c1 ; O=C(c1ccccc1)c1cccc(Nc2ccccc2)c1O ; COc1cc(Br)cc(C(=O)c2ccc(Nc3ccccc3)cc2)c1]

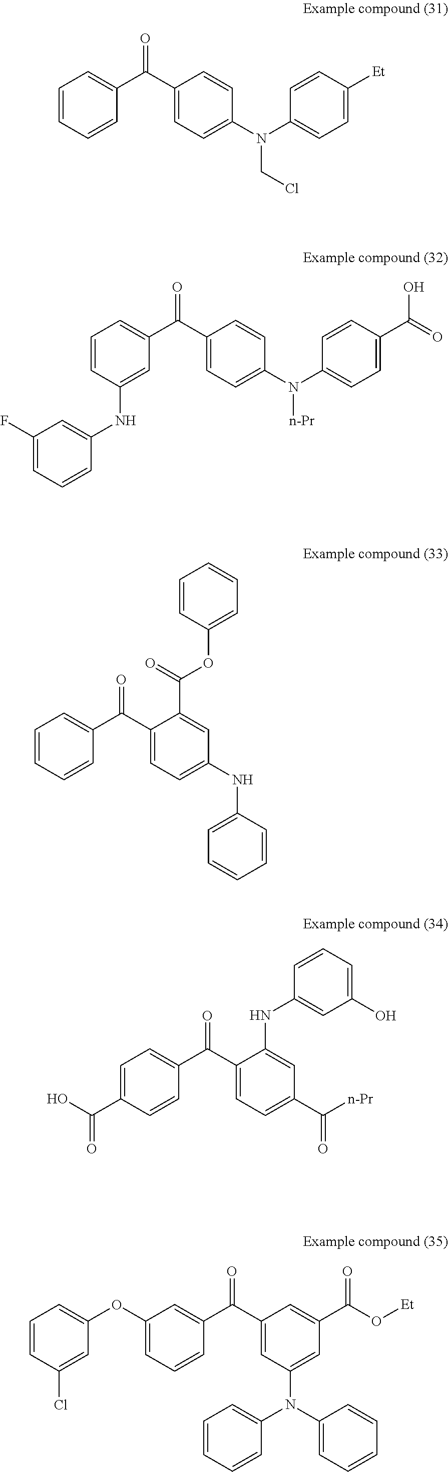

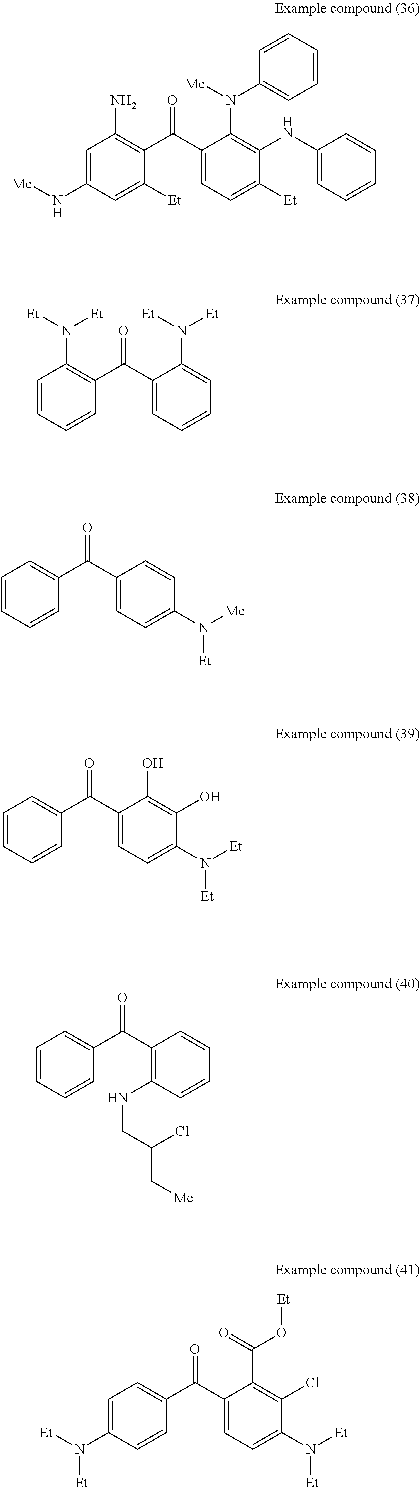 [SMILES: CCc1ccc(C(=O)c2c(N)cc(NC)cc2CC)c(N(C)c2ccccc2)c1Nc1ccccc1 ; CCN(CC)c1ccccc1C(=O)c1ccccc1N(CC)CC ; CCN(C)c1ccc(C(=O)c2ccccc2)cc1 ; CCN(CC)c1ccc(C(=O)c2ccccc2)c(O)c1O ; CCC(Cl)CNc1ccccc1C(=O)c1ccccc1 ; CCOC(=O)c1c(C(=O)c2ccc(N(CC)CC)cc2)ccc(N(CC)CC)c1Cl]

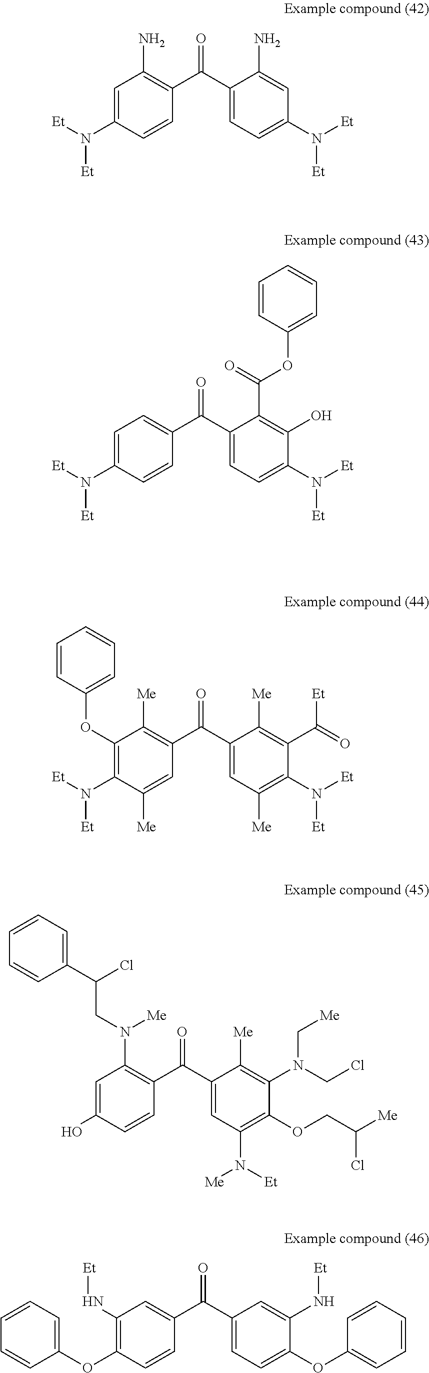 [SMILES: CCN(CC)c1ccc(C(=O)c2ccc(N(CC)CC)cc2N)c(N)c1 ; CCN(CC)c1ccc(C(=O)c2ccc(N(CC)CC)c(O)c2C(=O)Oc2ccccc2)cc1 ; CCC(=O)c1c(C)c(C(=O)c2cc(C)c(N(CC)CC)c(Oc3ccccc3)c2C)cc(C)c1N(CC)CC ; CCN(C)c1cc(C(=O)c2ccc(O)cc2N(C)CC(Cl)c2ccccc2)c(C)c(N(CC)CCl)c1OCC(C)Cl ; CCNc1cc(C(=O)c2ccc(Oc3ccccc3)c(NCC)c2)ccc1Oc1ccccc1]

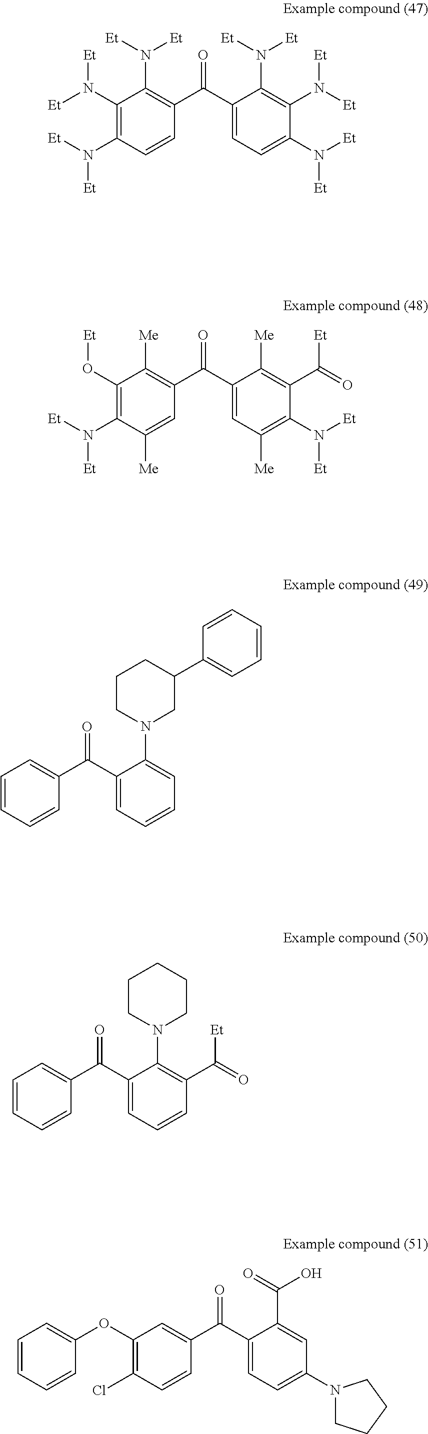 [SMILES: CCN(CC)c1ccc(C(=O)c2ccc(N(CC)CC)c(N(CC)CC)c2N(CC)CC)c(N(CC)CC)c1N(CC)CC ; CCOc1c(C)c(C(=O)c2cc(C)c(N(CC)CC)c(C(=O)CC)c2C)cc(C)c1N(CC)CC ; O=C(c1ccccc1)c1ccccc1N1CCCC(c2ccccc2)C1 ; CCC(=O)c1cccc(C(=O)c2ccccc2)c1N1CCCCC1 ; O=C(O)c1cc(N2CCCC2)ccc1C(=O)c1ccc(Cl)c(Oc2ccccc2)c1]

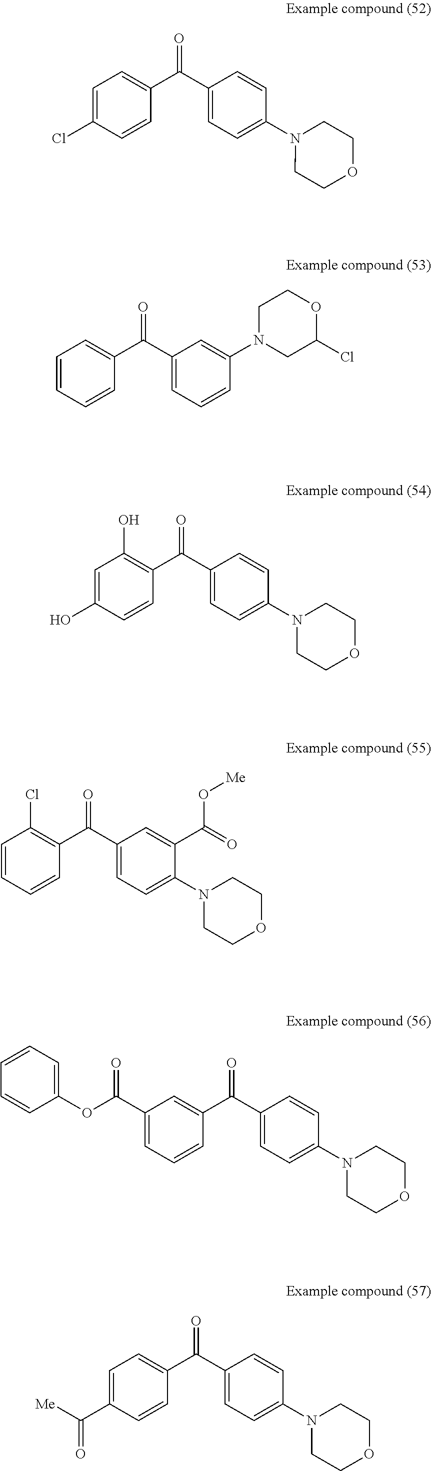 [SMILES: O=C(c1ccc(Cl)cc1)c1ccc(N2CCOCC2)cc1 ; O=C(c1ccccc1)c1cccc(N2CCOC(Cl)C2)c1 ; O=C(c1ccc(N2CCOCC2)cc1)c1ccc(O)cc1O ; COC(=O)c1cc(C(=O)c2ccccc2Cl)ccc1N1CCOCC1 ; O=C(Oc1ccccc1)c1cccc(C(=O)c2ccc(N3CCOCC3)cc2)c1 ; CC(=O)c1ccc(C(=O)c2ccc(N3CCOCC3)cc2)cc1]

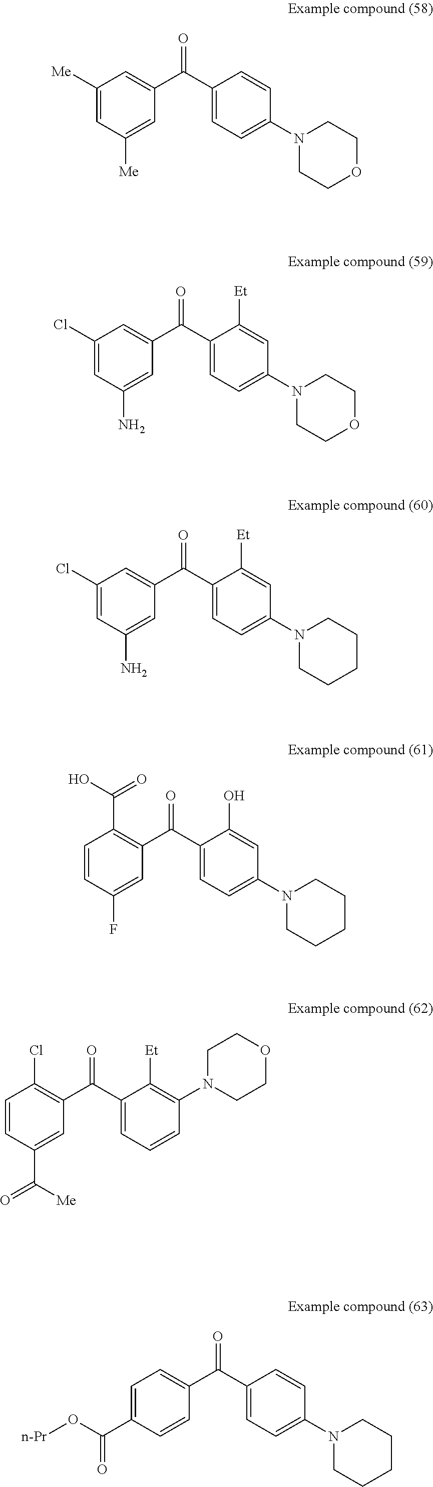

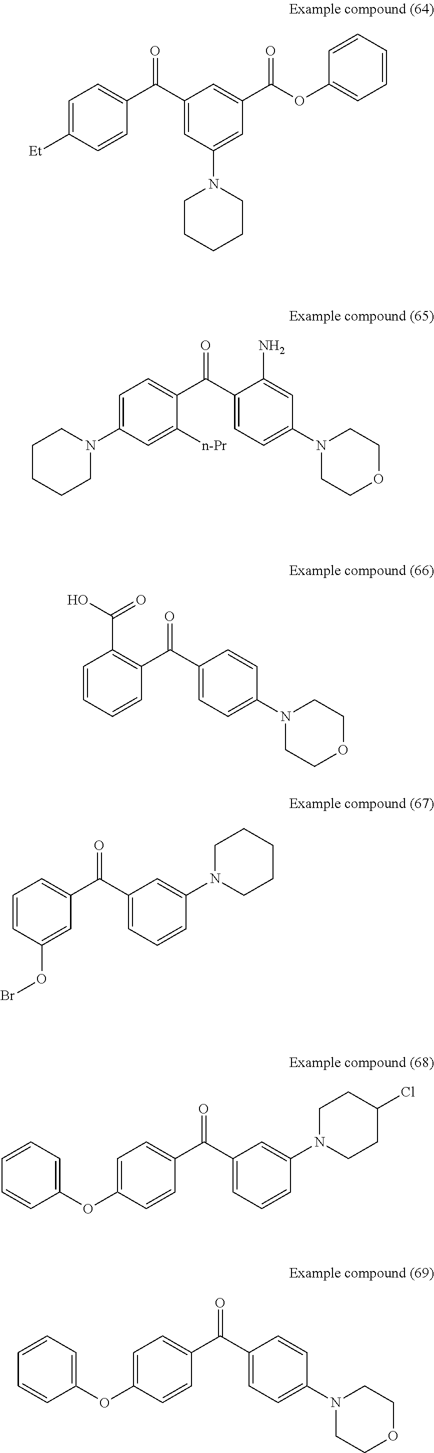

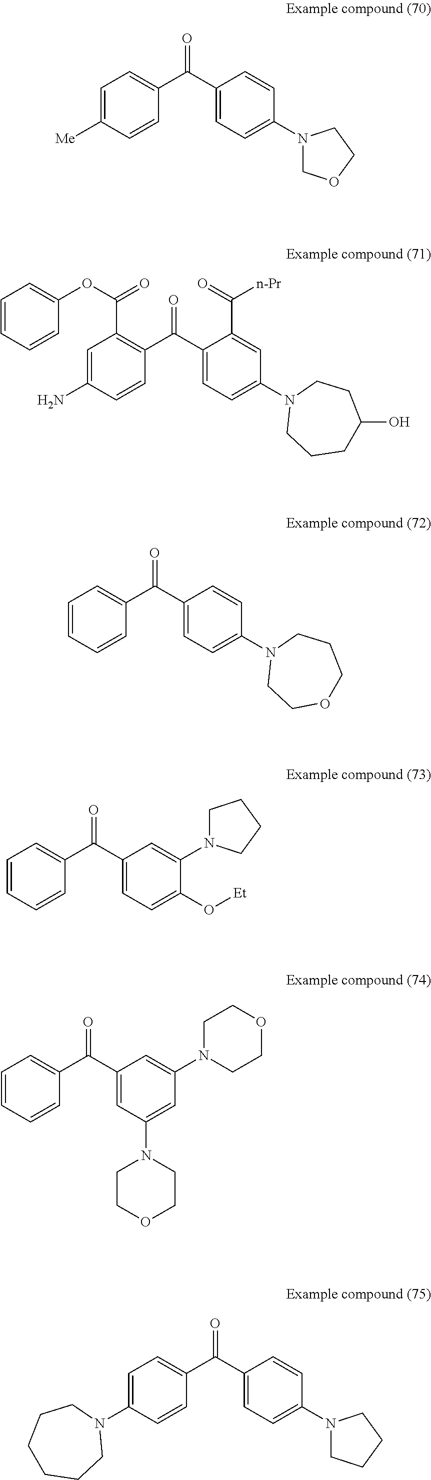

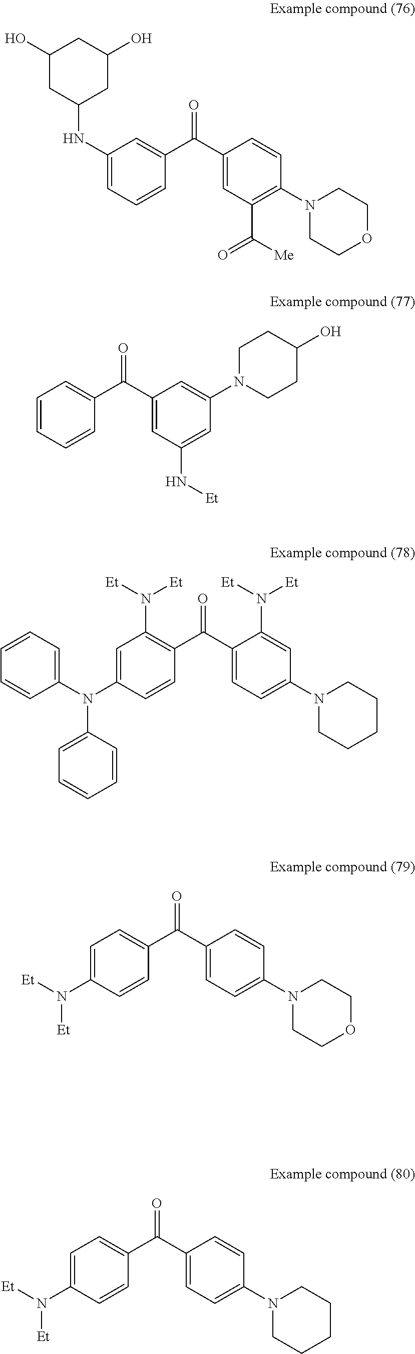 [SMILES: CC(=O)c1cc(C(=O)c2cccc(NC3CC(O)CC(O)C3)c2)ccc1N1CCOCC1 ; CCNc1cc(C(=O)c2ccccc2)cc(N2CCC(O)CC2)c1 ; CCN(CC)c1cc(N2CCCCC2)ccc1C(=O)c1ccc(N(c2ccccc2)c2ccccc2)cc1N(CC)CC ; CCN(CC)c1ccc(C(=O)c2ccc(N3CCOCC3)cc2)cc1 ; CCN(CC)c1ccc(C(=O)c2ccc(N3CCCCC3)cc2)cc1]

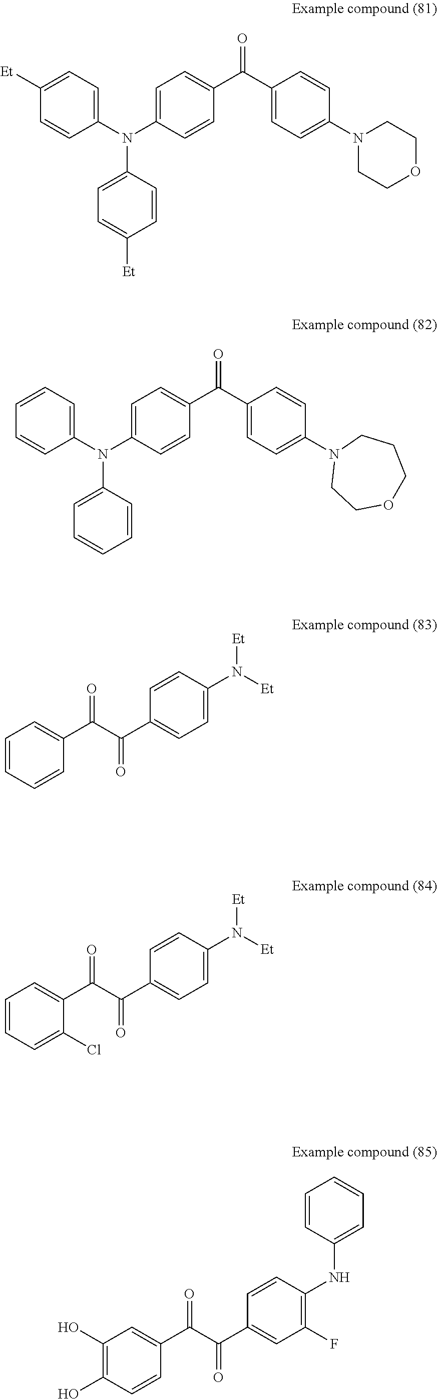 [SMILES: CCc1ccc(N(c2ccc(CC)cc2)c2ccc(C(=O)c3ccc(N4CCOCC4)cc3)cc2)cc1 ; O=C(c1ccc(N2CCCOCC2)cc1)c1ccc(N(c2ccccc2)c2ccccc2)cc1 ; CCN(CC)c1ccc(C(=O)C(=O)c2ccccc2)cc1 ; CCN(CC)c1ccc(C(=O)C(=O)c2ccccc2Cl)cc1 ; O=C(C(=O)c1ccc(Nc2ccccc2)c(F)c1)c1ccc(O)c(O)c1]

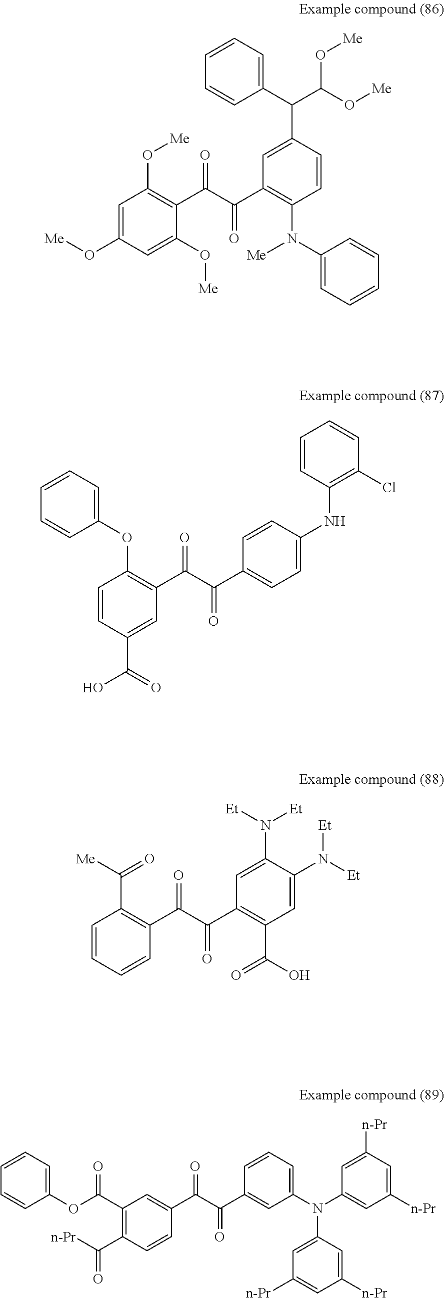

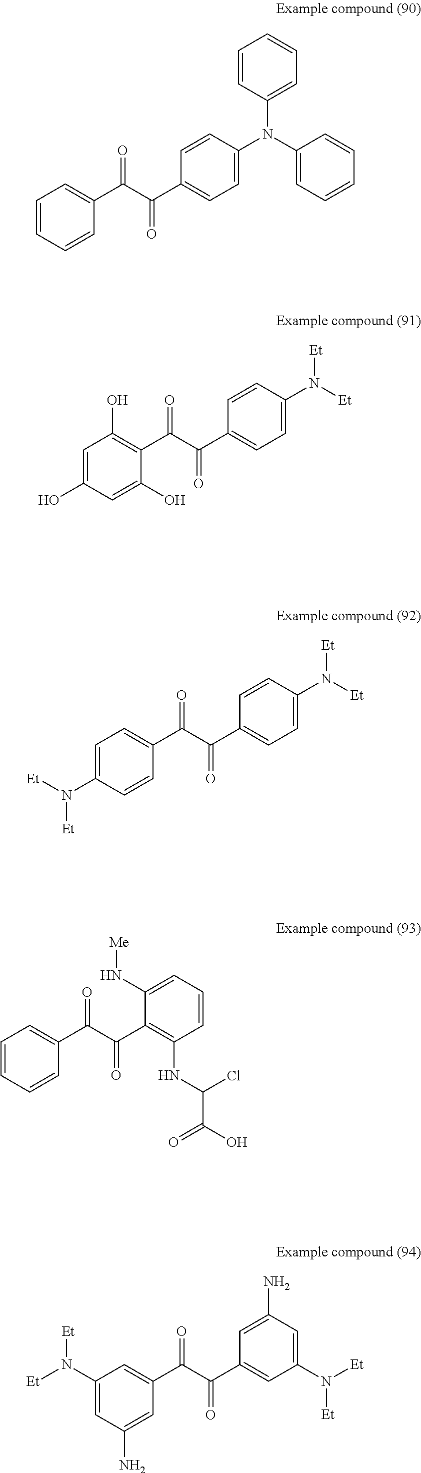 [SMILES: O=C(C(=O)c1ccc(N(c2ccccc2)c2ccccc2)cc1)c1ccccc1 ; CCN(CC)c1ccc(C(=O)C(=O)c2c(O)cc(O)cc2O)cc1 ; CCN(CC)c1ccc(C(=O)C(=O)c2ccc(N(CC)CC)cc2)cc1 ; CNc1cccc(NC(Cl)C(=O)O)c1C(=O)C(=O)c1ccccc1 ; CCN(CC)c1cc(N)cc(C(=O)C(=O)c2cc(N)cc(N(CC)CC)c2)c1]

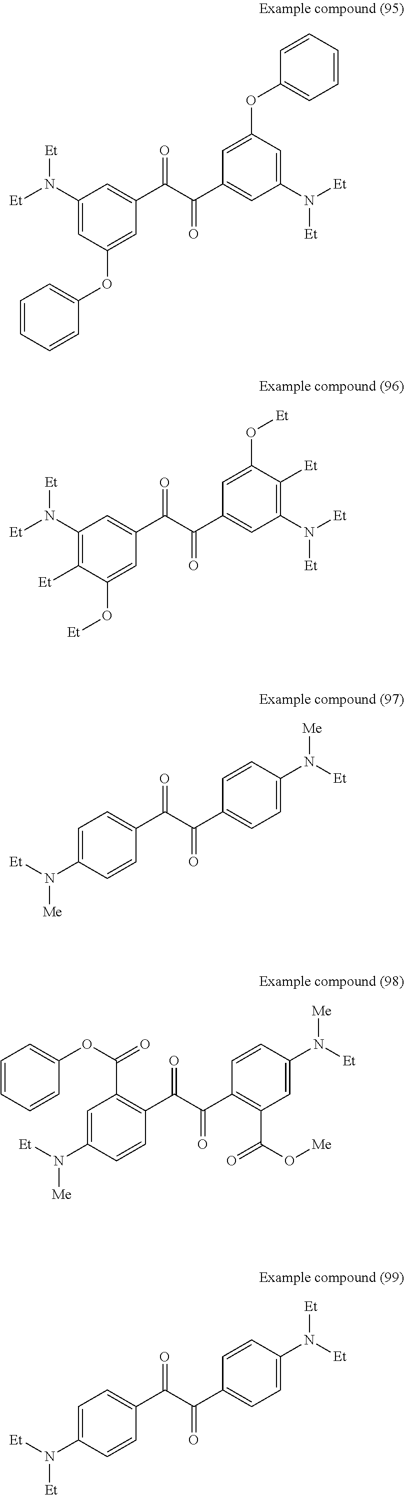 [SMILES: CCN(CC)c1cc(Oc2ccccc2)cc(C(=O)C(=O)c2cc(Oc3ccccc3)cc(N(CC)CC)c2)c1 ; CCOc1cc(C(=O)C(=O)c2cc(OCC)c(CC)c(N(CC)CC)c2)cc(N(CC)CC)c1CC ; CCN(C)c1ccc(C(=O)C(=O)c2ccc(N(C)CC)cc2)cc1 ; CCN(C)c1ccc(C(=O)C(=O)c2ccc(N(C)CC)cc2C(=O)Oc2ccccc2)c(C(=O)OC)c1 ; CCN(CC)c1ccc(C(=O)C(=O)c2ccc(N(CC)CC)cc2)cc1]

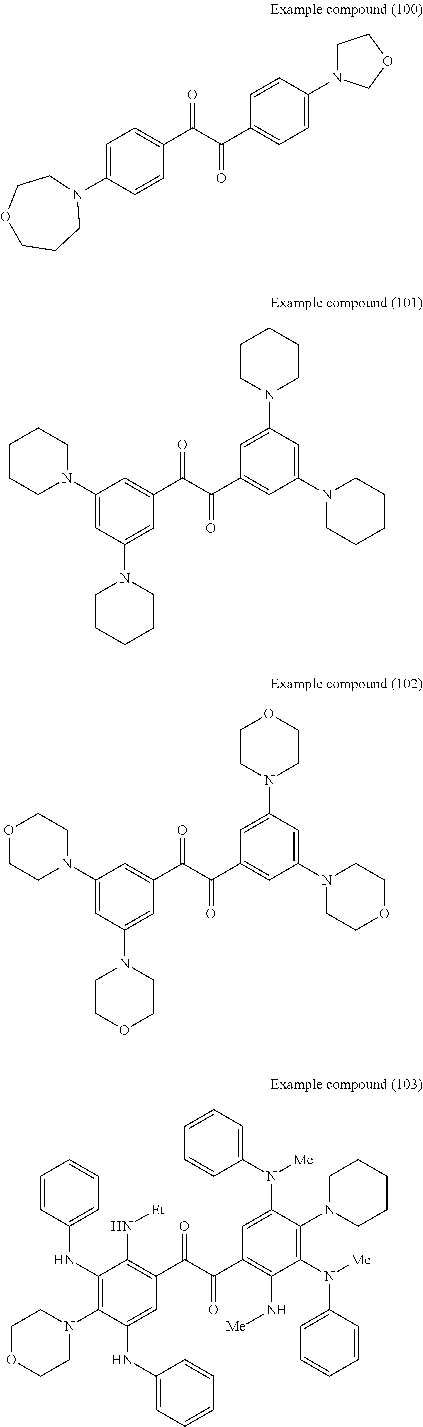 [SMILES: O=C(C(=O)c1ccc(N2CCOC2)cc1)c1ccc(N2CCCOCC2)cc1 ; O=C(C(=O)c1cc(N2CCCCC2)cc(N2CCCCC2)c1)c1cc(N2CCCCC2)cc(N2CCCCC2)c1 ; O=C(C(=O)c1cc(N2CCOCC2)cc(N2CCOCC2)c1)c1cc(N2CCOCC2)cc(N2CCOCC2)c1 ; CCNc1c(C(=O)C(=O)c2cc(N(C)c3ccccc3)c(N3CCCCC3)c(N(C)c3ccccc3)c2NC)cc(Nc2ccccc2)c(N2CCOCC2)c1Nc1ccccc1]

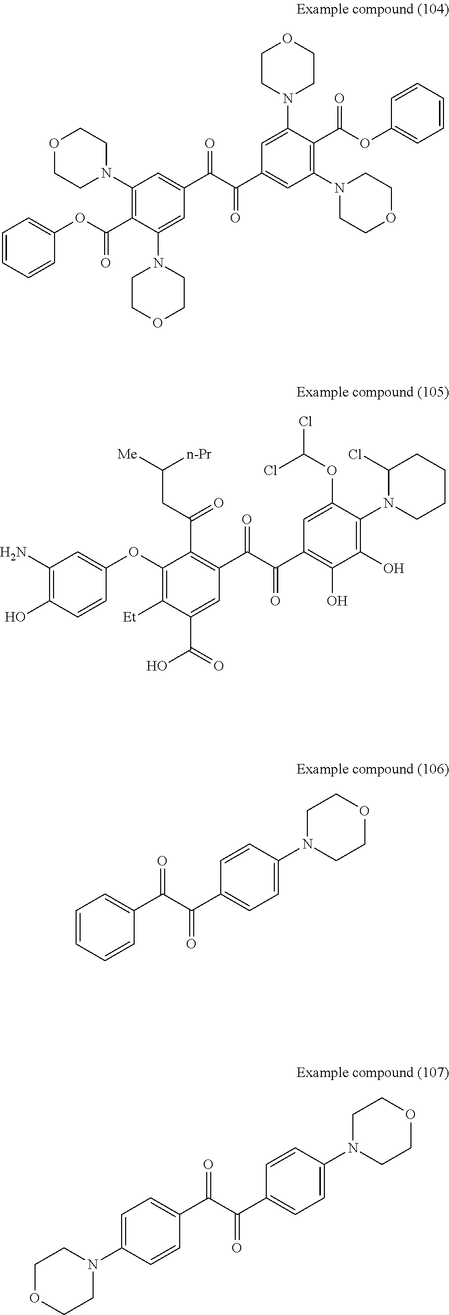

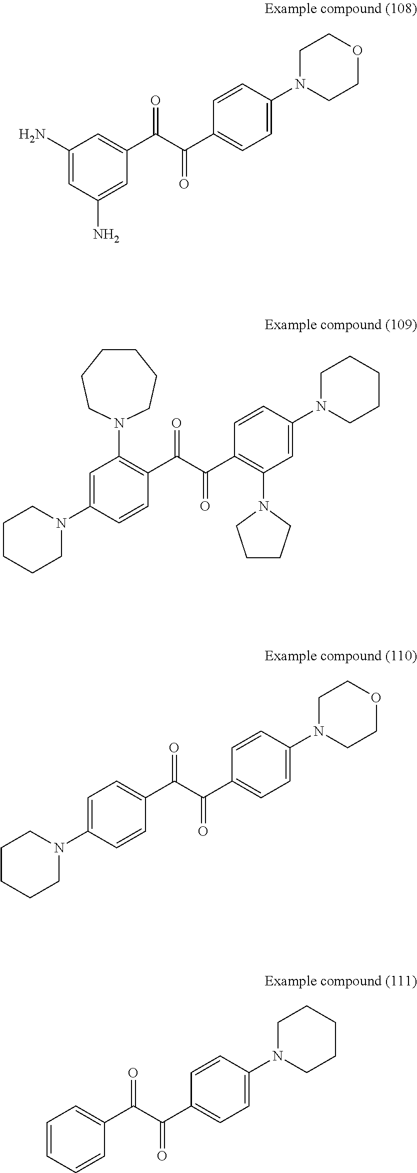 [SMILES: Nc1cc(N)cc(C(=O)C(=O)c2ccc(N3CCOCC3)cc2)c1 ; O=C(C(=O)c1ccc(N2CCCCC2)cc1N1CCCC1)c1ccc(N2CCCCC2)cc1N1CCCCCC1 ; O=C(C(=O)c1ccc(N2CCOCC2)cc1)c1ccc(N2CCCCC2)cc1 ; O=C(C(=O)c1ccc(N2CCCCC2)cc1)c1ccccc1]

In the example compounds, Me represents a methyl group, Et represents an ethyl group, and n-Pr represents an n-propyl group.

The amine compound represented by the formula (1) may be commercially available or may be synthesized as described below.

Aminobenzophenone is used as a raw material. A substituent group can be introduced into an amino group through a substitution reaction between aminobenzophenone and a halide. In particular, the reaction between aminobenzophenone and an aromatic halide with a metal catalyst is useful for synthesizing an amine compound substituted with an aryl group. Alternatively, a reductive amination reaction is useful for synthesizing an amine compound substituted with an alkyl group.

A specific synthesis example of the example compound (27) is described below. In the synthesis example, “parts” means “parts by mass”.

Infrared (IR) absorption spectrum was measured with a Fourier transform infrared spectrophotometer (trade name: FT/IR-420, made by Jasco Corporation). Nuclear magnetic resonance (NMR) spectrum was measured with a nuclear magnetic resonance apparatus (trade name: EX-400, made by JEOL Ltd).

### Synthesis Example

### Synthesis of the Example Compound (27)

In a three-neck flask, 50 parts of N,N-dimethylacetamide, 5.0 parts of 4,4′-diaminobenzophenone, 25.7 parts of iodotoluene, 9.0 parts of copper powder, and 9.8 parts of potassium carbonate were placed. The mixture was refluxed for 20 hours, and then solid components were removed by hot filtration. The solvent was evaporated under reduced pressure, and the residue was refined in a silica gel column (solvent: toluene) so as to produce 8.1 parts of the example compound (27).

The characteristic peaks of a measured IR absorption spectrum and a measured ¹H-NMR spectrum are described below.

IR (cm¹, KBr): 1646, 1594, 1508, 1318, 1277 and 1174

¹H-NMR (ppm, CDCl₃, 40° C.): δ=7.63 (d, 4H), 7.11 (d, 8H), 7.04 (d, 8H), 6.93 (d, 4H) and 2.33 (s, 12H)

In order to form an undercoat layer including titanium oxide crystal particles having an average primary particle diameter of 3 nm or more and 15 nm or less and an organic resin, a coating liquid to form an undercoat layer which includes a titania sol which includes titanium oxide crystal particles having an average primary particle diameter of 3 nm or more and 15 nm or less and an organic resin may be applied and dried.

A titania sol can be obtained, for example, by heating an aqueous solution of titanyl sulfate to hydrolyze it into precipitated hydrous titanium oxide, which is neutralized, filtrated, and washed with water to obtain a cake, and then by peptizing the cake with a strong acid such as hydrochloric acid and nitric acid.

Examples of the titania sol suitable for use are described below, although the present invention is not limited thereto.

Trade name: STS-100 (made by Ishihara Sangyo Kaisha, Ltd.; nitric acid sol containing 20% by mass of anatase titanium oxide crystal particles with an average primary particle diameter of 5 nm)
Trade name: TKS-201 (made by Tayca Corporation; hydrochloric acid sol containing 33% by mass of anatase titanium oxide crystal particles with an average primary particle diameter of 6 nm)
Trade name: TKS-202 (made by Tayca Corporation; nitric acid sol containing 33% by mass of anatase titanium oxide crystal particles with an average primary particle diameter of 6 nm)
Trade name: STS-01 (made by Ishihara Sangyo Kaisha, Ltd; nitric acid sol containing 30% by mass of anatase titanium oxide crystal particles with an average primary particle diameter of 7 nm)
Trade name: STS-02 (made by Ishihara Sangyo Kaisha, Ltd; hydrochloric acid sol containing 30% by mass of anatase titanium oxide crystal particles with an average primary particle diameter of 7 nm)

In order to form an undercoat layer including titanium oxide crystal particles having an average primary particle diameter of 3 nm or more and 15 nm or less and an organic resin, a coating liquid to form an undercoat layer which includes titanium oxide crystal particles having an average primary particle diameter of 3 nm or more and 15 nm or less and an organic resin may be applied and dried.

Examples of the titanium oxide crystal particles having an average primary particle diameter of 3 nm or more and 15 nm or less suitable for use are described below, although the present invention is not limited thereto.

Trade name: MT-05 (made by Tayca Corporation; rutile-type titanium oxide crystal particles with an average primary particle diameter of 10 nm)
Trade name: TKP-102 (made by Tayca Corporation; anatase titanium oxide crystal particles with an average primary particle diameter of 15 nm (titanium oxide content: 96% by mass))
Trade name: MT-150A (made by Tayca Corporation; rutile-type titanium oxide crystal particles with an average primary particle diameter of 15 nm)

In order to reduce ghosting while maintaining electrification property of an electrophotographic photosensitive member, titanium oxide crystal particles can have an average primary particle diameter of 3 nm or more and 15 nm or less.

More preferably, the titanium oxide crystal particles have an average primary particle diameter of 3 nm or more and 9 nm or less.

More preferably, the titanium oxide crystal particles having an average primary particle diameter of 3 nm or more and 15 nm or less are rutile-type titanium oxide crystal particles which contain tin atoms, so as to reduce ghosting after long-term use.

The rutile-type titanium oxide crystal particles are rutile-type titanium oxide crystal particles of which part of titanium atoms therein is replaced with tin atoms.

In order to effectively reduce ghosting after long-term use, the rutile-type titanium oxide crystal particles which contain tin atoms can have a molar ratio (Sn/Ti) of tin atoms to titanium atoms of 0.02 or more and 0.12 or less.

In order to improve the stability of a coating liquid to form an undercoat layer, the rutile-type titanium oxide for use in the present invention may further include zirconium atoms. In that case, in order to achieve both objectives to reduce ghosting and to improve the stability of a coating liquid to form an undercoat layer at higher levels, the molar ratio (Zr/Ti) of zirconium to titanium can be 0.01 or more and 0.05 or less.

The average primary particle diameter (average crystallite diameter) of titanium oxide crystal particles can be measured and calculated by the following method. Using an X-ray diffractometer, full-width at half maximum β (radian) of the peak and peak position 20 (radian) of the most intense interference line of titanium oxide are obtained, and the calculation is performed based on the following Scherrer equation.

Average primary particle diameter of titanium oxide crystal particles (average crystallite diameter) [nm]=K·λ/(β cos θ), (in the Scherrer equation, K represents a constant (0.9), λ (nm) represents measuring X-ray wavelength (CuKα line: 0.154 nm), β represents full-width at half maximum, and θ represents X-ray incident angle).

Alternatively, 100 pieces of primary particles alone, without secondary aggregated particles, are observed with a transmission electron microscope (TEM) so as to obtain the respective projected areas, from which equivalent circle diameters of the areas are calculated to obtain a volume average particle diameter as the average primary particle diameter (average crystallite diameter).

An electrophotographic photosensitive member having an undercoat layer which contains an amine compound represented by the formula (1), titanium oxide crystal particles having an average primary particle diameter of 3 nm or more and 15 nm or less, and an organic resin can reduce ghosting.

As described above, the electrophotographic photosensitive member includes a support, an undercoat layer formed on the support, and a photosensitive layer formed on the undercoat layer. The photosensitive layer may be a single layered photosensitive layer which contains a charge generating substance and a hole transporting substance in a single layer, or may be a laminated layered photosensitive layer laminated with a charge generating layer which contains a charge generating substance and a hole transporting layer which contains a hole transporting substance.

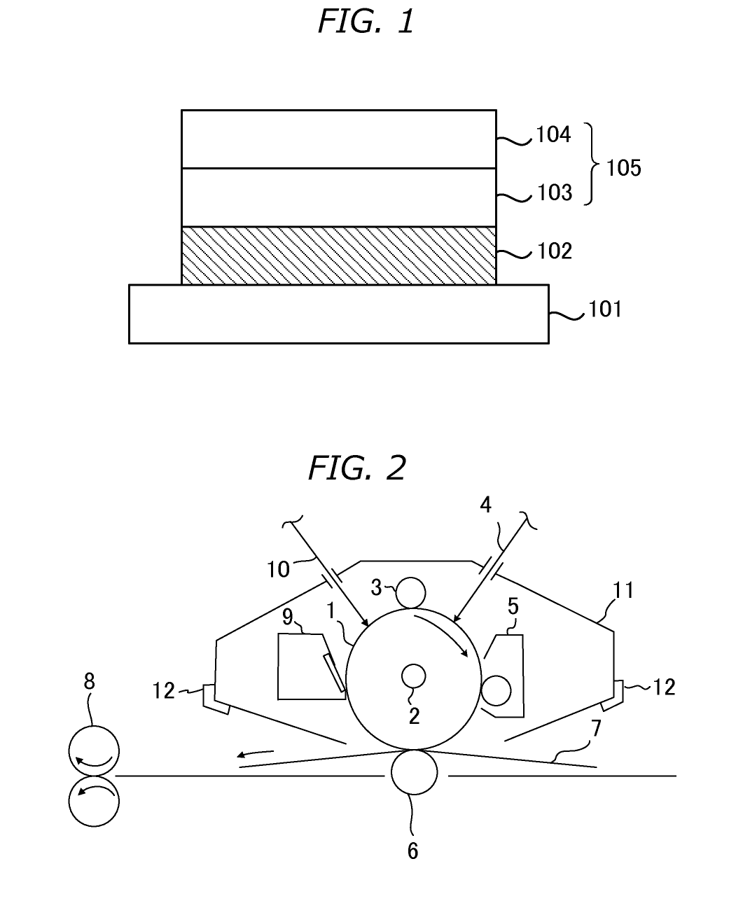

FIG. 1 is a schematic view of an example of the layer structure of the electrophotographic photosensitive member. In FIG. 1, a support 101, an undercoat layer 102, a charge generating layer 103, a hole transporting layer 104 and a photosensitive layer (laminated layered photosensitive layer) 105 are illustrated.

A support having electrical conductivity (conductive support) can be suitable for use. Examples of the conductive support include a support made of metal (alloy) such as aluminum, stainless steel and nickel, and a support made of metal, plastic or paper having a surface coated with a conductive film. The shape of the support can be, for example, in a cylindrical form or a film form. In particular, an aluminum support in a cylindrical form is excellent in mechanical strength, electrophotographic properties and cost. An element tube may be directly used as a support. Alternatively, the surface of an element tube may be physically processed such as by cutting and honing or chemical processed such as by anodic oxidation and acidizing, for use as a support. A support made of an element tube physically processed such as by cutting and honing so as to have a 10-point average surface roughness Rzjis according to JIS B0601:2001 of 0.8 μm or more has an excellent function to reduce interference stripes.

A conductive layer may be disposed between a support and an undercoat layer as required. A function to reduce interference stripes can be imparted particularly to a support of an element tube without processing by simply forming the conductive layer thereon, achieving positive effect on productivity and cost reduction.

The conductive layer can be formed by applying a coating liquid to form a conductive layer on a support and drying the produced coating film. The coating liquid to form a conductive layer can be prepared by dispersing conductive particles and a binding resin in a solvent. Examples of the conductive particles include tin oxide particles, indium oxide particles, titanium oxide particles, barium sulfate particles and carbon black. Examples of the binding resin include a phenol resin. Roughening particles may be added to a coating liquid to form a conductive layer as required.

From the viewpoints such as enhancing the function of reducing interference stripes and shielding (covering) flaws on the support, the conductive layer can have a film thickness of 5 to 40 μm, more preferably 10 to 30 μm.

An undercoat layer is disposed on a support or a conductive layer.

A coating liquid to form an undercoat layer is prepared by dissolving an amine compound represented by the formula (1), titanium oxide crystal particles having an average primary particle diameter of 3 nm or more and 15 nm or less, and an organic resin in a solvent. The coating liquid to form an undercoat layer is applied on a support or a conductive layer, and the produced coating film is dried to form an undercoat layer. An organic resin is preferably employed as a binder resin.

Examples of the organic resin for use in the undercoat layer include an acrylic resin, an allyl resin, an alkyd resin, an ethyl cellulose resin, an ethylene-acrylic acid co-polymer, an epoxy resin, a casein resin, a silicone resin, a gelatin resin, a phenol resin, a butyral resin, a polyacrylate resin, a polyacetal resin, a polyamide imide resin, a polyamide resin, a polyalkyl ether resin, a polyimide resin, a polyurethane resin, a polyester resin, a polyethylene resin, a polycarbonate resin, a polystyrene resin, a polysulfone resin, a polyvinylalcohol resin, a poly butadiene resin, a polypropylene resin, a urea resin, an agarose resin and a cellulose resin. In particular, a polyamide resin can be suitably used, considering the barrier function and the adhesion function.

Examples of the solvent for use in the coating liquid to form an undercoat layer include benzene, toluene, xylene, tetralin, chlorobenzene, dichloromethane, chloroform, trichloroethylene, tetrachloroethylene, carbon tetrachloride, methyl acetate, ethyl acetate, propyl acetate, methyl formate, ethyl formate, acetone, methyl ethyl ketone, cyclohexanone, diethyl ether, dipropyl ether, propylene glycol monomethyl ether, dioxane, methyl, tetrahydrofuran, water, methanol, ethanol, n-propanol, isopropanol, butanol, methyl cellosolve, methoxy propanol, dimethylformamide, dimethylacetamide and dimethyl sulfoxide.

In order to control the resistance value of an undercoat layer for improved potential stability, the undercoat layer may contain metal oxide particles. Examples of the metal oxide particles include zinc oxide particles and titanium oxide particles.

The undercoat layer can have a film thickness of 0.1 to 30.0 μm.

The content of the amine compound represented by the formula (1) in the undercoat layer can be 0.05% by mass or more and 15% by mass or less relative to the total mass of the undercoat layer, more preferably 0.1% by mass or more and 10% by mass or less.

The amine compound represented by the formula (1) contained in the undercoat layer may be noncrystal or crystal. Two or more kinds of the amine compounds represented by formula (1) may be used in combination.

The content of titanium oxide crystal particles having an average primary particle diameter of 3 nm or more and 15 nm or less in the undercoat layer can be 15% by mass or more and 55% by mass or less relative to the total mass of the undercoat layer. An excessively small content of titanium oxide crystal particles may impair the effect for reducing ghosting.

A photosensitive layer which contains a charge generating substance and a hole transporting substance is disposed on the undercoat layer.

A phthalocyanine pigment or an azo pigment can be suitably used as the charge generating substance, having a high sensitivity. In particular, a phthalocyanine pigment is more preferred.

Examples of the phthalocyanine pigment include a metal-free phthalocyanine and a metal phthalocyanine, which may include an axial ligand and a substituent group. Among the phthalocyanine pigments, oxytitanium phthalocyanine and gallium phthalocyanine which have high sensitivity while easily causing ghosting can be suitably used due to the efficient effect for reducing ghosting of the present invention. Among the gallium phthalocyanines, hydroxygallium phthalocyanine and chlorogallium phthalocyanine are suitably used.

Among the phthalocyanine pigments, a hydroxygallium phthalocyanine crystal with a crystal form having intense peaks at Bragg angles 2θ of 7.4°±0.3° and 28.2°±0.3° in characteristic X-ray diffraction with the CuKα line, a chlorogallium phthalocyanine crystal with a crystal form having intense peaks at Bragg angles 2θ±0.2° of 7.4°, 16.6°, 25.5° and 28.3° in characteristic X-ray diffraction with the CuKα line, and an oxytitanium phthalocyanine crystal with a crystal form having an intense peak at Bragg angle 2θ of 27.2°±0.2° in characteristic X-ray diffraction with the CuKα line are suitably used.

In particular, a hydroxygallium phthalocyanine crystal with a crystal form having intense peaks at Bragg angles 2θ±0.2° of 7.3°, 24.9° and 28.1° with the most intense peak at 28.1° in characteristic X-ray diffraction with the CuKα line, and a hydroxygallium phthalocyanine crystal with a crystal form having intense peaks at Bragg angles 2θ±0.2° of 7.5°, 9.9°, 16.3°, 18.6°, 25.1° and 28.3° in characteristic X-ray diffraction with the CuKα line are suitably used.

Examples of the binding resin in a charge generating layer for a laminated layered photosensitive layer include an insulating resin such as polyvinylbutyral, polyalylate, polycarbonate, polyester, a phenoxy resin, polyvinyl acetate, an acrylic resin, polyacrylamide, polyvinylpyridine, a cellulose type resin, an urethane resin, an epoxy resin, an agarose resin, a cellulose resin, casein, polyvinyl alcohol and polyvinyl pyrrolidone. Alternatively, an organic photoconductive polymer such as poly-N-vinylcarbazole, polyvinyl anthracene and polyvinylpyrene may be used.

Examples of the solvent for use in the coating liquid to form a charge generating layer include toluene, xylene, tetralin, chlorobenzene, dichloromethane, chloroform, trichloroethylene, tetrachloroethylene, carbon tetrachloride, methyl acetate, ethyl acetate, propyl acetate, methyl formate, ethyl formate, acetone, methyl ethyl ketone, cyclohexanone, diethyl ether, dipropyl ether, propylene glycol monomethyl ether, dioxane, methylal, tetrahydrofuran, water, methanol, ethanol, n-propanol, isopropanol, butanol, methyl cellosolve, methoxy propanol, dimethylformamide, dimethylacetamide and dimethyl sulfoxide.

The charge generating layer can be formed by applying the coating liquid to form a charge generating layer which contains a charge generating substance and, on an as needed basis, a binding resin, and drying the produced coating film.

The coating liquid to form a charge generating layer may be prepared by adding a charge generating substance alone to a solvent so as to be dispersed and then adding a binding resin thereto, or by adding a charge generating substance and a binding resin together to a solvent so as to be dispersed.

The charge generating layer can have a film thickness of 0.05 μm or more and 5μ or less.

The content of the charge generating substance in the charge generating layer can be 30% by mass or more and 90% by mass or less relative to the total mass of the charge generating layer, more preferably 50% by mass or more and 80% by mass or less.

Examples of the hole transporting substance include a triarylamine compound, a hydrazone compound, a stilbene compound, a pyrazoline compound, an oxazole compound, a thiazole compound and a triarllylmethane compound.

Examples of the binding resin in the hole transporting layer for a laminated layered photosensitive layer include an insulating resin such as polyvinylbutyral, polyalylate, polycarbonate, polyester, a phenoxy resin, polyvinyl acetate, an acrylic resin, a polyacrylamide resin, a polyamide resin, a polyvinylpyridine resin, a cellulose type resin, an urethane resin, an epoxy resin, an agarose resin, a cellulose resin, casein, polyvinyl alcohol and polyvinyl pyrrolidone. Alternatively, an organic photoconductive polymer such as poly-N-vinylcarbazole, polyvinyl anthracene and polyvinylpyrene may be used.

Examples of the solvent for use in the coating liquid to form a hole transporting layer include toluene, xylene, tetralin, monochlorobenzene, dichloromethane, chloroform, trichloroethylene, tetrachloroethylene, carbon tetrachloride, methyl acetate, ethyl acetate, propyl acetate, methyl formate, ethyl formate, acetone, methyl ethyl ketone, cyclohexanone, diethyl ether, dipropyl ether, propylene glycol monomethyl ether, dioxane, methylal, tetrahydrofuran, water, methanol, ethanol, n-propanol, isopropanol, butanol, methyl cellosolve, methoxy propanol, dimethylformamide, dimethylacetamide and dimethyl sulfoxide.

The hole transporting layer can be formed by applying a coating liquid to form a hole transporting layer which is obtained by dissolving a hole transporting substance and, as required, a binding resin in a solvent, and drying the produced coating film.

The hole transporting layer can have a film thickness of 5 μm or more and 40 μm or less.

The content of the hole transporting substance in the hole transporting layer can be 20% by mass or more and 80% by mass or less relative to the total mass of the hole transporting layer, more preferably 30% by mass or more and 60% by mass or less.

The photosensitive layer may also contain the amine compound represented by the formula (1). The amine compound represented by the formula (1) can be suitably contained in a charge generating layer for a laminated layered photosensitive layer.

The amine compound represented by the formula (1) contained in a photosensitive layer (charge generating layer) may also be noncrystalline or crystalline. Two or more kinds of the amine compounds represented by formula (1) may be used in combination.

The amine compound represented by the formula (1) contained in the undercoat layer and the amine compound represented by the formula (1) contained in the photosensitive layer (charge generating layer) can have the same structure.

In order to protect the photosensitive layer, a protective layer may be formed on the photosensitive layer. The protective layer can be formed by applying a coating liquid to form a protective layer, which is prepared by dissolving a resin such as a polyvinylbutyral, polyester, polycarbonate (e.g., polycarbonate Z and modified polycarbonate), nylon, polyimide, polyallylate, polyurethane, a styrene-butadiene copolymer, a styrene-acrylic acid co-polymer and a styrene-acrylonitrile co-polymer in a solvent, on a photosensitive layer, and drying and curing the produced coating film. The coating film may be cured with heating, electron beams or ultraviolet rays.

The protective layer can have a film thickness of 0.05 to 20 μm.

The protective layer may contain conductive particles, an ultraviolet absorbing agent, or lubricating particles such as fluorine atom-containing resin particles. Examples of the conductive particles include metal oxide particles such as tin oxide particles.

Examples of the application method of a coating liquid to form each layer include immersion coating (dip coating), spray coating, spinner coating, bead coating, blade coating and beam coating.

FIG. 2 is a schematic view of an electrophotographic apparatus provided with a process cartridge having an electrophotographic photosensitive member of the present invention.

An electrophotographic photosensitive member 1 having a cylindrical shape (drum shape), is rotation driven around an axis 2 at a predetermined circumferential speed (process speed) in an arrow direction.

The surface of the electrophotographic photosensitive member 1 is electrostatically charged to a predetermined positive or negative potential with a charging unit 3 during in a rotation process. Subsequently the surface of the electrophotographic photosensitive member 1 is irradiated with image exposing light beams 4 from an image exposure unit (not drawn in figure) so as to form an electrostatic latent image corresponding to objective image information. The image exposing light beams 4 are intensity-modulated in response to the time-series electric digital image signals of objective image information, outputted from, for example, an image exposure unit for slit exposure or laser beam scanning exposure.

The electrostatic latent image formed on the surface of the electrophotographic photosensitive member 1 is developed (normal development or reversal development) with toner stored in a development unit 5 so as to form a toner image on the surface of the electrophotographic photosensitive member 1. The toner image formed on the surface of the electrophotographic photosensitive member 1 is transferred to a transfer material 7 with a transfer unit 6. On this occasion, a bias voltage having a polarity reversal of the charge retained on the toner is applied to the transfer unit 6 from a bias power supply (not drawn in figure). A transfer material 7 of paper is taken out from a paper feeding part (not drawn in figure) so as to be fed between the electrophotographic photosensitive member 1 and the transfer unit 6 in synchronization with the rotation of the electrophotographic photosensitive member 1.

The transfer material 7 having a toner image transferred from the electrophotographic photosensitive member 1 is separated from the surface of the electrophotographic photosensitive member 1 and transported to an image fixation unit 8 for the fixation of the toner image. An image formed object (print or copy) is thus printed out from an electrophotographic apparatus.

After transfer of the toner image to the transfer material 7, the surface of the electrophotographic photosensitive member 1 is cleaned with a cleaning unit 9 to remove attached material such as toner (remaining toner after transfer). In a recently developed cleaner-less system, remaining toner may be directly removed after transfer with a development apparatus or the like. Subsequently the surface of the electrophotographic photosensitive member 1 is neutralized with pre-exposure beams 10 from a pre-exposure unit (not drawn in figure) and then repeatedly used for image formation. The pre-exposure unit is not necessarily required for a contact electrification unit 3 having a charging roller.

In the present invention, a plurality of components selected from the group consisting of the electrophotographic photosensitive member 1, an electrification unit 3, a development unit 5 and a cleaning unit 9 may be contained in a container and integrally supported to form a process cartridge detachable to an electrophotographic apparatus body. For example, the following constitution can be taken. At least one selected from the group consisting of an electrification unit 3, a development unit 5 and a cleaning unit 9 is integrally supported together with the electrophotographic photosensitive member 1 so as to form a cartridge. The cartridge constitutes a process cartridge 11 detachable to an electrophotographic apparatus body with a guiding unit 12 such as a rail of the electrophotographic apparatus body.

Image exposing light beams 4 may be reflected beams from or transmitted beams through a sheet of manuscript for an electrophotographic apparatus such as a copy machine and a printer. Alternatively, image exposing light beams 4 may be radiated beams produced by scanning of laser beams, driving of an LED array, or driving of a liquid crystal shutter array in response to signals from a manuscript reading sensor.

The electrophotographic photosensitive member of the present invention can be widely used in an electrophotography application field such as a laser beam printer, a CRT printer, an LED printer, a FAX, a liquid crystal printer and a laser engraving.

### EXAMPLES

The present invention is described further in detail in reference to specific examples below, although the present invention is not limited thereto. The film thickness of each of the layers in examples and Comparative Examples was obtained with an eddy-current film thickness meter (Fischerscope made by Fischer Instruments K.K.), or based on the specific gravity converted from a mass per unit area. “Parts” in examples means “parts by mass”.

### Manufacturing Example 1

Manufacturing of acidic rutile-type titania sol

A cake was obtained by a method according to the description in “Section 1: Manufacturing of rutile-type titanium oxide hydrosol” in example 1 of Japanese Patent Application Laid-Open No. 2007-246351. Water and 36% hydrochloric acid were added to the cake to be agitated. As a result, an acidic titania sol (hydrochloric acid sol) with a pH of 1.6 which has a content of titanium oxide crystal particles of 15% by mass and contains zirconium atoms and tin atoms was obtained. The molar ratio (Sn/Ti) of tin atoms to titanium atoms was 0.053, and the molar ratio (Zr/Ti) of zirconium atoms to titanium atoms was 0.019. The titanium oxide crystal particles obtained by drying the acidic titania sol at 100° C. had a rutile-type crystal form in X-ray diffraction and an average primary particle diameter (average crystallite diameter) of 8 nm. In other words, the acidic titania sol of manufacturing example 1 which contains zirconium atoms and tin atoms contains 15% by mass of rutile-type titanium oxide crystal particles having an average primary particle diameter of 8 nm which contain zirconium atoms and tin atoms.

### Manufacturing Example 2

Manufacturing of acidic rutile-type titania sol

In a glass beaker, 40 g of an aqueous solution of sodium silicate with a silicon oxide concentration of 10% (silicon oxide: 4 g) and 2 g of an aqueous solution of 48% sodium hydroxide were fed, and diluted with ion-exchange water to a total solution amount of 1200 g. Into the liquid, a total amount of 1000 g of the ion-exchange water-diluted acidic rutile-type titania sol which contains zirconium atoms and tin atoms obtained in manufacturing example 1 of 267 g (titanium oxide: 40 g) was slowly dripped with agitation. Subsequently the liquid was heated to 80° C. and then adjusted to pH 8 with an aqueous solution of hydrochloric acid so as to be aged at the same temperature for 2 hours. The liquid was cooled to room temperature and adjusted to pH 3 with an aqueous solution of citric acid. The liquid was ultrafiltrated overnight with an ultrafiltration module refilled with the amount of ion-exchange water equal to the filtration amount so as to reduce electrolyte components. The liquid was then concentrated. As a result, an acidic titania sol with a pH of 5.6 which contains zirconium atoms and tin atoms and has a content of titanium oxide crystal particles surface-coated with silica of 15% by mass was obtained. The titanium oxide crystal particles obtained by drying the acidic titania sol at 100° C. had a rutile-type crystal form in X-ray diffraction and an average primary particle diameter (average crystallite diameter) of 8 nm. The dried solid content was 20% by mass. In other words, the acidic titania sol of manufacturing example 2 which contains zirconium atoms and tin atoms contains 15% by mass of rutile-type titanium oxide crystal particles surface-coated with silica having an average primary particle diameter of 8 nm which contain zirconium atoms and tin atoms.

### Example 1

A support (cylindrical support) was formed of an aluminum cylinder having a diameter of 24 mm and a length of 257 mm.

Subsequently, 60 parts of barium sulfate particles coated with tin oxide (trade name: Passtran PC1, made by Mitsui Mining & Smelting Co., Ltd.), 15 parts of titanium oxide particles (trade name: TITANIX JR, made by Tayca Corporation), 43 parts of a resol-type phenol resin (trade name: Phenolite J-325 made by DIC Corporation, solid content: 70% by mass), 0.015 parts of silicone oil (trade name: SH28PA, made by Dow Corning Toray Co., Ltd.), 3.6 parts of silicone resin particles (trade name: Tospearl 120, made by Momentive Performance Materials Inc.), 50 parts of 2-methoxy-1-propanol, and 50 parts of methanol were put in a ball mill, and dispersed for 20 hours so as to prepare a coating liquid to form a conductive layer. The coating liquid to form a conductive layer was applied on a support with immersion coating, and the produced coating film was heated at 140° C. for 1 hour so as to be cured. A conductive layer having a film thickness of 20 μm was thus formed.

Subsequently 25 parts of N-methoxymethyl nylon 6 (trade name: Tresin EF-30T, made by Nagase Chemitex Corporation) was dissolved in a mixed solvent of 225 parts of n-butanol (heating dissolution at 65° C.) to form a solution, which was then cooled. The solution was filtrated with a membrane filter (trade name: FP-022, pore diameter: 0.22 μm, made by Sumitomo Electric Industries, Ltd). Subsequently 56 parts of the acidic rutile-type titania sol which contains tin atoms produced in manufacturing example 1 was added to the filtrate. The mixture was put in a sand mill device using 500 parts of glass beads having an average diameter of 0.8 mm and dispersed for 30 minutes at 800 rpm.

After dispersion treatment, the glass beads were separated with mesh filtration. The separate liquid was diluted with methanol and n-butanol so as to achieve a solid content of 3.0% and a solvent ratio of methanol to n-butanol of 2:1.

To 500 parts of the diluted solution, 0.03 parts of the example compound (2) (product code: B1275, made by Tokyo Chemical Industry Co., Ltd.) was added to prepare the coating liquid to form an undercoat layer.

The content of the titanium oxide crystal particles in the coating liquid to form an undercoat layer was 25% by mass relative to the total mass of the dried solid content in the coating liquid to form an undercoat layer.

The coating liquid to form an undercoat layer was diluted by 50 times with water/isopropyl alcohol=8/2 solvent, and dripped on a glass plate so as to be dried for transmission electron microscope (TEM) observation. The observation confirmed that the titanium oxide had an average primary particle diameter of 8 nm. In the following, the average primary particle diameter of titanium oxide was confirmed in the same method.

The coating liquid to form an undercoat layer was applied to a conductive layer with immersion coating. The produced coating film was dried at 100° C. for 10 minutes to form an undercoat layer having a film thickness of 0.45 μm.

A hydroxygallium phthalocyanine crystal (charge generating substance) with a crystal form having intense peaks at Bragg angles 2θ±0.2° of 7.3°, 24.9° and 28.1° with the most intense peak at 28.1° in characteristic X-ray diffraction with the CuKα line was prepared. Then, 20 parts of the charge generating substance, 0.2 parts of calixarene compound represented by the following formula (2),

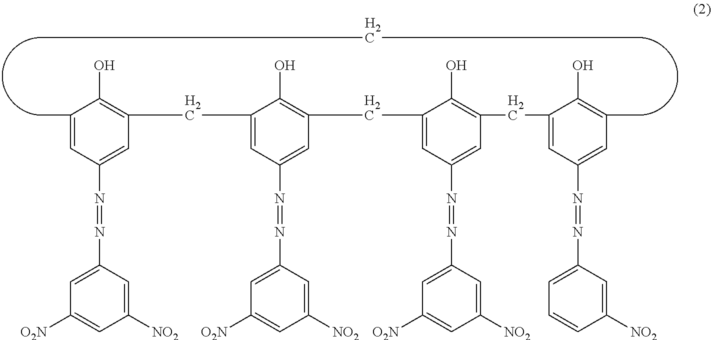

10 parts of polyvinylbutyral (trade name: BX-1, made by Sekisui Chemical Co., Ltd.), and 519 parts of cyclohexanone were put in a sand mill with glass beads having a diameter of 1 mm for dispersion treatment for 4 hours. To the dispersion liquid, 764 parts of ethyl acetate was added to prepare a coating liquid to form a charge generating layer. The coating liquid to form a charge generating layer was applied to the undercoat layer with immersion coating. The produced coating film was dried at 100° C. for 10 minutes to form the charge generating layer having a film thickness of 0.18 μm.

Subsequently 70 parts of triarylamine compound (hole transporting substance) represented by the following formula (3),

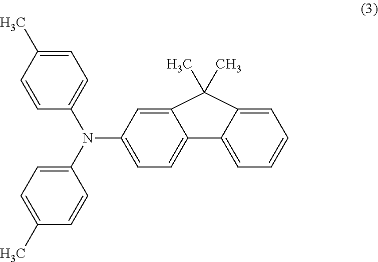 [SMILES: Cc1ccc(N(c2ccc(C)cc2)c2ccc3c(c2)C(C)(C)c2ccccc2-3)cc1]

parts of triarylamine compound (hole transporting substance) represented by the following formula (4),

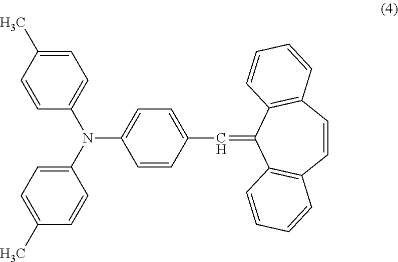 [SMILES: Cc1ccc(N(c2ccc(C)cc2)c2ccc(C=C3c4ccccc4C=Cc4ccccc43)cc2)cc1]

and 100 parts of polycarbonate (trade name: Iupilon Z-200, made by Mitsubishi Engineering-Plastics Corporation) were dissolved in 630 parts of monochlorobenzene so as to prepare a coating liquid to form a hole transporting layer. The coating liquid to form a hole transporting layer was applied to the charge generating layer by immersion coating. The produced coating film was dried at 120° C. for 1 hour to form a hole transporting layer having a film thickness of 19 μm.

The coating film of each of the conductive layer, the undercoat layer, the charge generating layer and the hole transporting layer was dried in an oven set at each temperature. Those that follow are the same.

The electrophotographic photosensitive member of Example 1 in a cylindrical shape (drum shape) was thus manufactured.

### Example 2

The electrophotographic photosensitive member of Example 2 was manufactured as in Example 1 except that the preparation of the coating liquid to form a charge generating layer in Example 1 was changed to the following.

First, 20 parts of hydroxygallium phthalocyanine crystal (charge generating substance) with a crystal form having intense peaks at Bragg angles 2θ±0.2° of 7.3°, 24.9° and 28.1° with the most intense peak at 28.1° in characteristic X-ray diffraction with the CuKα line was prepared. The charge generating substance, 0.2 parts of the compound represented by the formula (2), 0.01 parts of the example compound (2) (product code: B1275, made by Tokyo Chemical Industry Co., Ltd.), 10 parts of polyvinylbutyral, and 553 parts of cyclohexanone were put in a sand mill with glass beads having a diameter of 1 mm so as to be dispersed for 4 hours. Subsequently 815 parts of ethyl acetate was added to prepare the coating liquid to form a charge generating layer.

### Example 3

The electrophotographic photosensitive member of Example 3 was manufactured as in Example 2 except that 0.01 parts of the example compound (2) used in preparation of the coating liquid to form a charge generating layer in Example 2 was changed to 0.2 parts of the example compound (1).

### Example 4

The electrophotographic photosensitive member of Example 4 was manufactured as in Example 1 except that the usage of the example compound (2) in preparation of the coating liquid to form an undercoat layer in Example 1 was changed from 0.03 parts to 0.003 parts.

### Example 5

The electrophotographic photosensitive member of Example 5 was manufactured as in Example 1 except that the usage of the example compound (2) in preparation of the coating liquid to form an undercoat layer in Example 1 was changed from 0.03 parts to 0.15 parts.

### Example 6

The electrophotographic photosensitive member of Example 6 was manufactured as in Example 1 except that the usage of the example compound (2) in preparation of the coating liquid to form an undercoat layer in Example 1 was changed from 0.03 parts to 0.45 parts.

### Example 7

The electrophotographic photosensitive member of Example 7 was manufactured as in Example 1 except that the usage of the example compound (2) in preparation of the coating liquid to form an undercoat layer in Example 1 was changed from 0.03 parts to 1.5 parts.

### Example 8

The electrophotographic photosensitive member of Example 8 was manufactured as in Example 1 except that the usage of the example compound (2) in preparation of the coating liquid to form an undercoat layer in Example 1 was changed from 0.03 parts to 3 parts.

### Example 9

The usage of the acidic rutile-type titania sol which contains tin atoms produced in manufacturing example 1 in preparation of the coating liquid to form an undercoat layer in Example 1 was changed from 56 parts to 19 parts. The electrophotographic photosensitive member of Example 9 was manufactured as in Example 1 further except that 0.03 parts of the example compound (2) was changed to 0.3 parts of the example compound (1) (product code: 159400050, made by Acros Organics).

The content of the titanium oxide crystal particles in the coating liquid to form an undercoat layer was 10% by mass relative to the total mass of the dried solid content in the coating liquid to form an undercoat layer.

### Example 10

The electrophotographic photosensitive member of Example 10 was manufactured as in Example 9 except that the usage of the acidic rutile-type titania sol which contains tin atoms produced in manufacturing example 1 in preparation of the coating liquid to form an undercoat layer in Example 9 was changed from 56 parts to 167 parts. The content of the titanium oxide crystal particles in the coating liquid to form an undercoat layer was 50% by mass relative to the total mass of the dried solid content in the coating liquid to form an undercoat layer.

### Example 11

The electrophotographic photosensitive member of Example 11 was manufactured as in Example 9 except that the usage of the acidic rutile-type titania sol which contains tin atoms produced in manufacturing example 1 in preparation of the coating liquid to form an undercoat layer in Example 9 was changed from 56 parts to 250 parts. The content of the titanium oxide crystal particles in the coating liquid to form an undercoat layer was 60% by mass relative to the total mass of the dried solid content in the coating liquid to form an undercoat layer.

### Example 12

The electrophotographic photosensitive member of Example 12 was manufactured as in Example 1 except that the preparation of the coating liquid to form an undercoat layer in Example 1 was changed to the following.

First, 25 parts of N-methoxymethyl nylon 6 (trade name: Tresin EF-30T, made by Nagase Chemitex Corporation) was dissolved in a mixed solvent of 225 parts of n-butanol (heating dissolution at 65° C.) to form a solution, which was then cooled. The solution was filtrated with a membrane filter (trade name: FP-022, pore diameter: 0.22 μm, made by Sumitomo Electric Industries, Ltd). Subsequently 22 parts of the acidic titania sol (acid sol), (trade name: STS-100, made by Ishihara Sangyo Kaisha, Ltd.; nitric acid sol; titanium oxide content: 20% by mass) which contains anatase titanium oxide crystal particles having an average primary particle diameter of 5 nm was added to the filtrate. The mixture was put in a sand mill device using 500 parts of glass beads having an average diameter of 0.8 mm and dispersed for 2 hours at 1500 rpm.

After dispersion treatment, the glass beads were separated with mesh filtration. The separate liquid was diluted with methanol and n-butanol so as to achieve a solid content of 3.0% and a solvent ratio of methanol to n-butanol of 2:1. To 500 parts of the diluted solution, 0.03 parts of the example compound (2) (product code: B1275, made by Tokyo Chemical Industry Co., Ltd.) was added to prepare the coating liquid to form an undercoat layer. The content of the titanium oxide crystal particles in the coating liquid to form an undercoat layer was 15% by mass relative to the total mass of the dried solid content in the coating liquid to form an undercoat layer.

### Example 13

The electrophotographic photosensitive member of Example 13 was manufactured as in Example 12 except that 22 parts of the acidic titania sol (trade name: STS-100) in Example 12 was changed to 13 parts of acidic titania sol (acid sol) (trade name: TKS-201, made by Tayca Corporation; hydrochloric acid sol; titanium oxide content: 33% by mass) which contains anatase titanium oxide crystal particles with an average primary particle diameter of 6 nm. The content of the titanium oxide crystal particles in the coating liquid to form an undercoat layer was 15% by mass relative to the total mass of the dried solid content in the coating liquid to form an undercoat layer.

### Example 14

The electrophotographic photosensitive member of Example 14 was manufactured as in Example 12 except that 22 parts of the acidic titania sol (trade name: STS-100) in Example 12 was changed to 15 parts of acidic titania sol (acid sol) (trade name: STS-01, made by Ishihara Sangyo Kaisha, Ltd.; nitric acid sol; titanium oxide content: 30% by mass) which contains anatase titanium oxide crystal particles with an average primary particle diameter of 7 nm. The content of the titanium oxide crystal particles in the coating liquid to form an undercoat layer was 15% by mass relative to the total mass of the dried solid content in the coating liquid to form an undercoat layer.

### Example 15

The electrophotographic photosensitive member of Example 15 was manufactured as in Example 12 except that 0.03 parts of the example compound (2) used in preparation of the coating liquid to form an undercoat layer in Example 12 was changed to 0.3 parts of the example compound (3) (product code: B1212, made by Tokyo Chemical Industry Co., Ltd).

### Example 16

In example 12, 22 parts of the acidic titania sol (trade name: STS-100) was changed to 13 parts of acidic titania sol (acid sol) which contains anatase titanium oxide crystal particles with an average primary particle diameter of 6 nm (trade name: TKS-202, made by Tayca Corporation; nitric acid sol; titanium oxide content: 33% by mass) and 0.03 parts of the example compound (2) was changed to 0.3 parts of the example compound (9). The electrophotographic photosensitive member of Example 16 was manufactured as in Example 12 further except that the preparation of the coating liquid to form a charge generating layer was changed to the following.

First, 20 parts of hydroxygallium phthalocyanine crystal (charge generating substance) with a crystal form having intense peaks at Bragg angles 2θ±0.2° of 7.3°, 24.9° and 28.1° with the most intense peak at 28.1° in characteristic X-ray diffraction with the CuKα line was prepared. The charge generating substance, 0.2 parts of the compound represented by the formula (2), 0.01 parts of the example compound (2), 10 parts of polyvinylbutyral (BX-1), and 553 parts of cyclohexanone were put in a sand mill with glass beads having a diameter of 1 mm so as to be dispersed for 4 hours. Subsequently 815 parts of ethyl acetate was added to prepare the coating liquid to form a charge generating layer.

### Example 17

The electrophotographic photosensitive member of Example 17 was manufactured as in Example 12 except that the preparation of the coating liquid to form an undercoat layer in Example 12 was changed to the following.

First, 25 parts of N-methoxymethyl nylon 6 (Tresin EF-30T) was dissolved in a mixed solvent of 225 parts of n-butanol (heating dissolution at 65° C.) to form a solution, which was then cooled. The solution was filtrated with a membrane filter (FP-022). Subsequently 2.9 parts of rutile-type titanium oxide crystal particles having an average primary particle diameter of 15 nm without surface treatment (trade name: TKP-102, made by Tayca Corporation; titanium oxide content: 96% by mass) was added to the filtrate. The mixture was put in a sand mill device using 500 parts of glass beads having an average diameter of 0.8 mm and dispersed for 7 hours at 1500 rpm. After dispersion treatment, the glass beads were separated with mesh filtration. The separate liquid was diluted with methanol and n-butanol so as to achieve a solid content of 3.0% and a solvent ratio of methanol to n-butanol of 2:1. To 500 parts of the diluted solution, 0.3 parts of the example compound (14) was added to prepare the coating liquid to form an undercoat layer.

The content of the titanium oxide crystal particles in the coating liquid to form an undercoat layer was 10% by mass relative to the total mass of the dried solid content in the coating liquid to form an undercoat layer.

### Example 18

In example 17, 2.9 parts of titanium oxide crystal particles (trade name: TKP-102) was changed to 25 parts of rutile-type titanium oxide crystal particles surface-coated with alumina and silica having an average primary particle diameter of 10 nm (trade name: MT-05, made by Tayca Corporation). The electrophotographic photosensitive member of Example 18 was manufactured as in Example 17 further except that the example compound (14) was changed to the example compound (12).

The content of the titanium oxide crystal particles in the coating liquid to form an undercoat layer was 50% by mass relative to the total mass of the dried solid content in the coating liquid to form an undercoat layer.

### Example 19

In example 17, 2.9 parts of titanium oxide crystal particles (trade name: TKP-102) was changed to 2.8 parts of rutile-type titanium oxide crystal particles (trade name: MT-150A, made by Tayca Corporation) having an average primary particle diameter of 15 nm without surface treatment. The electrophotographic photosensitive member of Example 19 was manufactured as in Example 17 further except that the example compound (14) was changed to the example compound (18).

The content of the titanium oxide crystal particles in the coating liquid to form an undercoat layer was 10% by mass relative to the total mass of the dried solid content in the coating liquid to form an undercoat layer.

### Example 20

In Example 1, the acidic rutile-type titania sol which contains tin atoms produced in manufacturing example 1 was changed to the acidic rutile-type titania sol which contains tin atoms produced in manufacturing example 2. The electrophotographic photosensitive member of Example 20 was manufactured as in Example 1 further except that 0.03 parts of the example compound (2) was changed to 0.3 parts of the example compound (26).

The content of the titanium oxide crystal particles in the coating liquid to form an undercoat layer was 25% by mass relative to the total mass of the dried solid content in the coating liquid to form an undercoat layer.

### Example 21

The electrophotographic photosensitive member of Example 21 was manufactured as in Example 1 except that the formation of the charge generating layer in Example 1 was changed to the following.

First, 20 parts of oxytitanium phthalocyanine crystal (charge generating substance) with a crystal form having intense peaks at Bragg angles 2θ±0.2° of 9.0°, 14.2°, 23.9° and 27.1° in characteristic X-ray diffraction with the CuKα line was prepared. The charge generating substance, 10 parts of polyvinylbutyral (BX-1), and 519 parts of cyclohexanone were put in a sand mill with glass beads having a diameter of 1 mm so as to be dispersed for 4 hours. Subsequently 764 parts of ethyl acetate was added to prepare the coating liquid to form a charge generating layer. The coating liquid to form a charge generating layer was applied to the undercoat layer with immersion coating. The coating liquid was dried at 100° C. for 10 minutes so as to form a charge generating layer having a film thickness of 0.18 μm.

### Comparative Example 1

The electrophotographic photosensitive member of Comparative Example 1 was manufactured as in Example 1 except that the example compound (2) in Example 1 was not used in preparation of the coating liquid to form an undercoat layer.

### Comparative Example 2

The electrophotographic photosensitive member of Comparative Example 2 was manufactured as in Example 1 except that 0.03 parts of the example compound (2) in Example 1 was changed to 0.3 parts of bisazo pigment represented by the following formula (5).

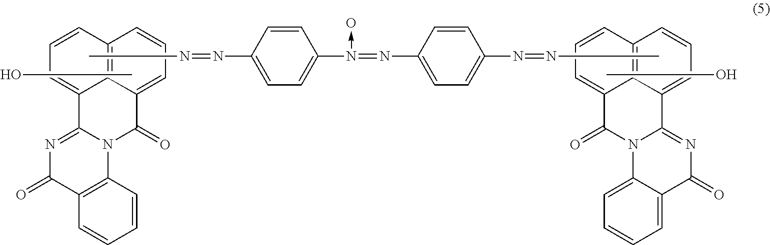

### Comparative Example 3

The electrophotographic photosensitive member of Comparative Example 3 was manufactured as in Example 1 except that 0.03 parts of the example compound (2) in Example 1 was changed to 0.3 parts of benzophenone compound (product code: 378259, made by Sigma Aldrich Co.) represented by the following formula (6).

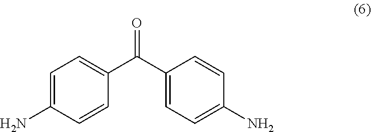 [SMILES: Nc1ccc(C(=O)c2ccc(N)cc2)cc1]

### Comparative Example 4

The electrophotographic photosensitive member of Comparative Example 4 was manufactured as in Example 1 except that 0.03 parts of the example compound (2) in Example 1 was changed to 0.3 parts of a compound (product code: B0483, made by Tokyo Chemical Industry Co., Ltd.) represented by the following formula (7).

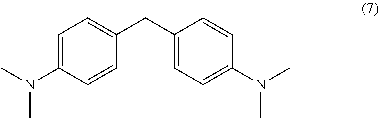

### Comparative Example 5

In example 2, the example compound (2) used in preparation of the coating liquid to form an undercoat layer was changed to an anthraquinone compound represented by the following formula (8). The electrophotographic photosensitive member of Comparative Example 5 was manufactured as in Example 2 further except that 0.01 parts of the example compound (2) used in preparation of the coating liquid to form a charge generating layer was changed to 0.2 parts of an anthraquinone compound represented by the following formula (8).

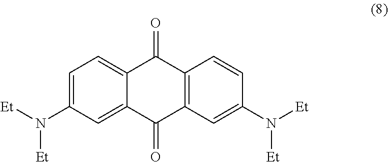 [SMILES: CCN(CC)c1ccc2c(c1)C(=O)c1cc(N(CC)CC)ccc1C2=O]

(In the formula (8), Et represents an ethyl group.)

### Comparative Example 6

The electrophotographic photosensitive member of Comparative Example 6 was manufactured as in Example 12 except that 0.03 parts of the example compound (2) in Example 12 was changed to 0.3 parts of benzophenone compound (product code: 126217, made by Sigma Aldrich Co.) represented by the following formula (9).

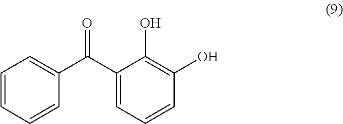 [SMILES: O=C(c1ccccc1)c1cccc(O)c1O]

### Comparative Example 7

The electrophotographic photosensitive member of Comparative Example 7 was manufactured as in Example 12 except that 0.03 parts of the example compound (2) in Example 12 was changed to 0.3 parts of benzophenone compound represented by the following formula (10).

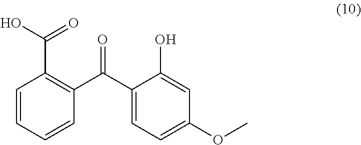 [SMILES: COc1ccc(C(=O)c2ccccc2C(=O)O)c(O)c1]

### Comparative Example 8

The electrophotographic photosensitive member of Comparative Example 8 was manufactured as in Example 13 except that the example compound (2) in Example 13 was changed to a benzophenone compound (product code: D1688, made by Tokyo Chemical Industry Co., Ltd.) represented by the following formula (11).

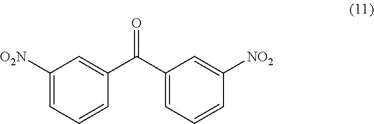 [SMILES: O=C(c1cccc([N+](=O)[O-])c1)c1cccc([N+](=O)[O-])c1]

### Comparative Example 9

The electrophotographic photosensitive member of Comparative Example 9 was manufactured as in Example 14 except that the example compound (2) in Example 14 was changed to a benzophenone (product code: B0083, made by Tokyo Chemical Industry Co., Ltd.) represented by the following formula (12).

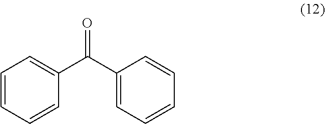 [SMILES: O=C(c1ccccc1)c1ccccc1]

### Comparative Example 10

The electrophotographic photosensitive member of Comparative Example 10 was manufactured as in Example 1 except that 0.03 parts of the example compound (2) in Example 1 was changed to 0.3 parts of a compound represented by the following formula (13).

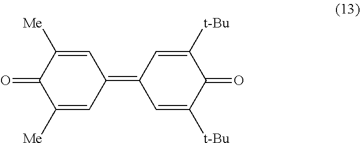 [SMILES: CC1=CC(=C2C=C(C(C)(C)C)C(=O)C(C(C)(C)C)=C2)C=C(C)C1=O]

### Comparative Example 11

The electrophotographic photosensitive member of Comparative Example 11 was manufactured as in Example 1 except that the preparation of the coating liquid to form an undercoat layer in Example 1 was changed to the following.

First, 25 parts of N-methoxymethyl nylon 6 (Tresin EF-30T) was dissolved in a mixed solvent of 225 parts of n-butanol (heating dissolution at 65° C.) to form a solution, which was then cooled. The solution was filtrated with a membrane filter (FP-022). Subsequently 4.5 parts of anatase titanium oxide crystal particles having an average primary particle diameter of 30 nm without surface treatment (trade name: AMT-600, made by Tayca Corporation; titanium oxide content: 98% by mass) was added to the filtrate. The mixture was put in a sand mill device using 500 parts of glass beads having an average diameter of 0.8 mm and dispersed for 7 hours at 1500 rpm. After dispersion treatment, the glass beads were separated with mesh filtration. The separate liquid was diluted with methanol and n-butanol so as to achieve a solid content of 3.0% and a solvent ratio of methanol to n-butanol of 2:1. To 500 parts of the diluted solution, 0.03 parts of the example compound (2) was added to prepare the coating liquid to form an undercoat layer.

The content of the titanium oxide crystal particles in the coating liquid to form an undercoat layer was 15% by mass relative to the total mass of the dried solid content in the coating liquid to form an undercoat layer.

### Comparative Example 12

The electrophotographic photosensitive member of Comparative Example 12 was manufactured as in Comparative Example 11 except that the titanium oxide crystal particles (trade name: AMT-600) in Comparative Example 11 was changed to rutile-type titanium oxide crystal particles having an average primary particle diameter of 35 nm without surface treatment (trade name: MT-500B, made by Tayca Corporation; titanium oxide content: 98% by mass).

The content of the titanium oxide crystal particles in the coating liquid to form an undercoat layer was 15% by mass relative to the total mass of the dried solid content in the coating liquid to form an undercoat layer.

### Comparative Example 13

The electrophotographic photosensitive member of Comparative Example 13 was manufactured as in Comparative Example 11 except that the titanium oxide crystal particles (trade name: AMT-600) in Comparative Example 11 was changed to rutile-type titanium oxide crystal particles having an average primary particle diameter of 50 nm without surface treatment (trade name: MT-600B, made by Tayca Corporation).

The content of the titanium oxide crystal particles in the coating liquid to form an undercoat layer was 15% by mass relative to the total mass of the dried solid content in the coating liquid to form an undercoat layer.

### Comparative Example 14

The electrophotographic photosensitive member of Comparative Example 14 was manufactured as in Comparative example 11 except that 0.03 parts of the example compound (2) used in preparation of the coating liquid to form an undercoat layer in Comparative example 11 was changed to 0.3 parts of the example compound (1).

### Comparative Example 15

The electrophotographic photosensitive member of Comparative Example 15 was manufactured as in Example 21 except that the example compound (2) in the preparation of the coating liquid to form an undercoat layer in Example 21 was not used.

### Evaluation of Examples 1 to 21 and Comparative Examples 1 to 15

The electrophotographic photosensitive members of Examples 1 to 21 and Comparative Examples 1 to 15 were evaluated on ghosting under a normal temperature and normal humidity environment of 23° C./50% RH and under a low temperature and low humidity environment of 15° C./10% RH.

A laser beam printer made by Hewlett Packard Company (trade name: Color Laser Jet CP3525dn) was modified to use as an electrophotographic apparatus for evaluation. As a result of modification, a pre-exposure light was unlit and electrification conditions and exposure amount were variably controlled. In addition, a manufactured electrophotographic photosensitive member was mounted in a process cartridge for cyan color and attached to the station of the process cartridge for cyan, allowing for operation without mounting of process cartridges for other colors to the laser beam printer main unit.

In outputting an image, the process cartridge for cyan color alone was attached to the laser beam printer main unit or a copy machine main unit so that a single color image was outputted using cyan toner alone.

The surface potential of an electrophotographic photosensitive member was set at −500 V for an initial dark part and −100 V for a bright part. In the measurement of the surface potential of an electrophotographic photosensitive member for potential setting, a potential probe (trade name: model 6000B-8, made by Trek Japan Co., Ltd.) was mounted for use at the development position of a process cartridge. The potential at the center of an electrophotographic photosensitive member in the longitudinal direction was measured with a surface potential meter (trade name: model 344, made by Trek Japan Co., Ltd).

First, ghosting was evaluated under a normal temperature and normal humidity environment of 23° C./50% RH. Subsequently, a durability test was performed with 1,000 sheets of paper fed through under the same environment, and ghosting was evaluated immediately after the durability test. Evaluation results under a normal temperature and normal humidity environment are described in Table 1.

Subsequently, an electrophotographic photosensitive member was left to stand under a low temperature and low humidity environment of 15° C./10% RH together with an electrophotographic apparatus for evaluation for 3 days so as to evaluate ghosting. Subsequently, a durability test was performed with 1,000 sheets of paper fed through under the same environment, and ghosting was evaluated immediately after the durability test. Evaluation results under a low temperature and low humidity environment are described in Table 1.

In the durability test with paper fed through, an image of character E with a coverage rate of 1% was formed on a plain paper of A4 size with cyan single color.

The evaluation criteria are as follows.

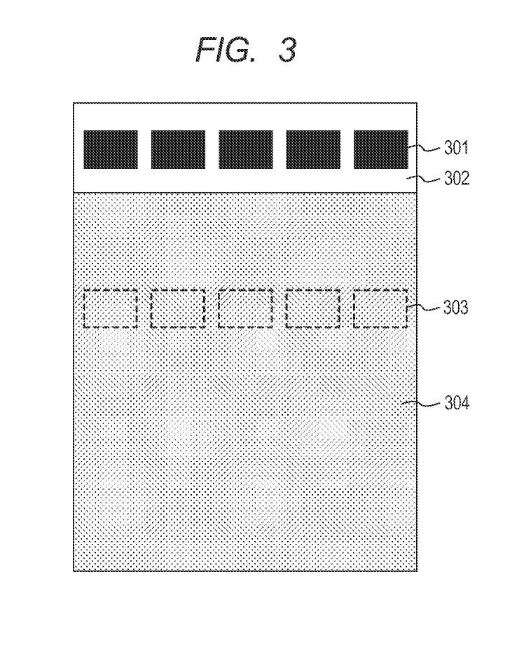

A ghosting evaluation image was formed by outputting square images at the head portion with solid black 301 and then outputting a half tone image 304 with one dot KEIMA pattern. In FIG. 3, the reference sign 302 denotes a white portion (white image) and the reference sign 303 denotes a portion in which ghost can be found. A solid white image was outputted on a first sheet, and then 5 sheets of the ghosting evaluation image were outputted in succession. Subsequently a solid black image was outputted on one sheet, and then 5 sheets of the ghosting evaluation image were outputted once again. The images were outputted in this order and evaluation was performed based on the total 10 sheets of the ghosting evaluation image.

The difference in concentration between the image concentration of the one dot KEIMA pattern and the image concentration of the ghost portion (portion where ghosting may occur) was measured with a spectral densitometer (trade name: X-Rite 504/508, made by X-Rite Inc.) so as to evaluate ghosting. The measurement was performed at 10 points for one sheet of ghost evaluation image. The average of the 10 points was assumed to be the result of the one sheet. All of the 10 ghost evaluation images were measured in the same way, and then the average thereof was obtained as the difference in concentration for each example. The smaller the difference in concentration is, the smaller the degree of ghosting becomes, achieving better results. In Table 1, “initial” means the difference in concentration before durability test with 1,000 sheets of paper fed through under the normal temperature and normal humidity environment or the low temperature and low humidity environment, and “after durability” means the difference in concentration after durability test with 1,000 sheets of paper fed through under the normal temperature and normal humidity environment or the low temperature and low humidity environment.

TABLE 1

| | Temperature difference | | | |
|---|---|---|---|---|
| | Under normal | | Under low | |
| | temperature | | temperature and | |
| | and normal humidity | | low humidity | |
| | environment | | environment | |
| | Initial | After durability | Initial | After durability |
| Example 1 | 0.023 | 0.026 | 0.024 | 0.029 |
| Example 2 | 0.020 | 0.022 | 0.022 | 0.025 |
| Example 3 | 0.021 | 0.024 | 0.024 | 0.029 |
| Example 4 | 0.026 | 0.032 | 0.030 | 0.042 |
| Example 5 | 0.024 | 0.028 | 0.026 | 0.033 |
| Example 6 | 0.025 | 0.030 | 0.028 | 0.038 |
| Example 7 | 0.026 | 0.032 | 0.029 | 0.039 |
| Example 8 | 0.028 | 0.034 | 0.031 | 0.045 |
| Example 9 | 0.025 | 0.030 | 0.029 | 0.041 |
| Example 10 | 0.024 | 0.028 | 0.025 | 0.032 |
| Example 11 | 0.025 | 0.030 | 0.029 | 0.040 |
| Example 12 | 0.026 | 0.032 | 0.029 | 0.041 |
| Example 13 | 0.026 | 0.031 | 0.029 | 0.039 |
| Example 14 | 0.026 | 0.032 | 0.030 | 0.043 |
| Example 15 | 0.028 | 0.034 | 0.031 | 0.044 |
| Example 16 | 0.026 | 0.032 | 0.031 | 0.045 |
| Example 17 | 0.028 | 0.035 | 0.032 | 0.046 |
| Example 18 | 0.028 | 0.036 | 0.032 | 0.047 |
| Example 19 | 0.028 | 0.035 | 0.031 | 0.044 |
| Example 20 | 0.026 | 0.032 | 0.030 | 0.042 |
| Example 21 | 0.025 | 0.030 | 0.029 | 0.040 |
| Comparative Example 1 | 0.039 | 0.053 | 0.046 | 0.106 |
| Comparative Example 2 | 0.041 | 0.060 | 0.048 | 0.114 |
| Comparative Example 3 | 0.039 | 0.053 | 0.044 | 0.101 |
| Comparative Example 4 | 0.039 | 0.056 | 0.045 | 0.103 |
| Comparative Example 5 | 0.038 | 0.054 | 0.044 | 0.101 |
| Comparative Example 6 | 0.040 | 0.059 | 0.048 | 0.111 |
| Comparative Example 7 | 0.041 | 0.059 | 0.048 | 0.114 |
| Comparative Example 8 | 0.040 | 0.060 | 0.049 | 0.115 |
| Comparative Example 9 | 0.041 | 0.060 | 0.049 | 0.115 |
| Comparative Example 10 | 0.041 | 0.057 | 0.048 | 0.109 |
| Comparative Example 11 | 0.036 | 0.048 | 0.043 | 0.095 |
| Comparative Example 12 | 0.035 | 0.049 | 0.042 | 0.092 |
| Comparative Example 13 | 0.039 | 0.057 | 0.047 | 0.108 |
| Comparative Example 14 | 0.039 | 0.057 | 0.047 | 0.110 |
| Comparative Example 15 | 0.040 | 0.058 | 0.047 | 0.111 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2012-254339, filed Nov. 20, 2012, and 2013-221107, filed Oct. 24, 2013, which are hereby incorporated by reference herein in their entirety.

What is claimed is:

1. An electrophotographic photosensitive member comprising:
a support,
an undercoat layer formed on the support, and
a photosensitive layer formed on the undercoat layer;
wherein:
the photosensitive layer comprises a charge generating substance and a hole transporting substance, and
the undercoat layer comprises:
an amine compound represented by the following formula (1);
titanium oxide crystal particles having an average primary particle diameter of 3 nm or more and 15 nm or less; and
an organic resin; 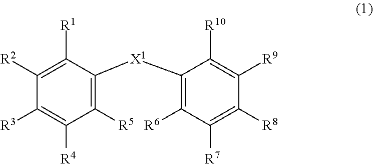
where,
R¹ to R¹⁰ each independently represent a hydrogen atom, a halogen atom, a hydroxy group, a carboxyl group, an alkoxycarbonyl group, an aryloxycarbonyl group, a substituted or unsubstituted acyl group, a substituted or unsubstituted alkyl group, a substituted or unsubstituted alkoxy group, a substituted or unsubstituted aryloxy group, a substituted or unsubstituted amino group, or a substituted or unsubstituted cyclic amino group;
at least one of R¹ to R¹⁰ is an amino group substituted with a substituted or unsubstituted aryl group, an amino group substituted with a substituted or unsubstituted alkyl group, or a substituted or unsubstituted cyclic amino group;
X¹ represents one of a carbonyl group or a dicarbonyl group.

2. The electrophotographic photosensitive member according to claim 1, wherein at least one of R¹ to R¹⁰ is an amino group substituted with a substituted or unsubstituted alkyl group.

3. The electrophotographic photosensitive member according to claim 2, wherein the amino group substituted with a substituted or unsubstituted alkyl group is a dialkylamino group.

4. The electrophotographic photosensitive member according to claim 3, wherein the dialkylamino group is a dimethylamino group or a diethylamino group.

5. The electrophotographic photosensitive member according to claim 1, wherein at least one of R¹ to R¹⁰ is a substituted or unsubstituted cyclic amino group.

6. The electrophotographic photosensitive member according to claim 5, wherein the substituted or unsubstituted cyclic amino group is a morpholino group or a 1-piperidyl group.

7. The electrophotographic photosensitive member according to claim 1, wherein the content of the amine compound represented by the formula (1) in the undercoat layer is 0.05% by mass or more and 15% by mass or less relative to the total mass of the undercoat layer.

8. The electrophotographic photosensitive member according to claim 1, wherein the titanium oxide crystal particles are rutile-type titanium oxide crystal particles of which part of titanium atoms therein is replaced with tin atoms.

9. The electrophotographic photosensitive member according to claim 1, wherein the content of titanium oxide crystal particles in the undercoat layer is 15% by mass or more and 55% by mass or less relative to the total mass of the undercoat layer.

10. The electrophotographic photosensitive member according to claim 1, wherein the photosensitive layer comprises a hydroxygallium phthalocyanine crystal with a crystal form having intense peaks at Bragg angles 2θ of 7.4°±0.3° and 28.2°±0.3° in X-ray diffraction with the CuKα line as a charge generating substance.

11. The electrophotographic photosensitive member according to claim 1, wherein the photosensitive layer comprises a charge generating layer which contains the charge generating substance, and a hole transporting layer which contains the hole transporting substance formed on the charge generating layer.

12. The electrophotographic photosensitive member according to claim 11, wherein the charge generating layer contains the charge generating substance and an amine compound represented by the formula (1).

13. The electrophotographic photosensitive member according to claim 12, wherein the amine compound represented by the formula (1) contained in the undercoat layer and the amine compound represented by the formula (1) contained in the charge generating layer have the same structure.

14. A process cartridge detachably attachable to a main body of an electrophotographic apparatus, wherein the process cartridge integrally supports:
the electrophotographic photosensitive member according to claim 1, and
at least one unit selected from the group consisting of a charging unit, a developing unit, a transferring unit and a cleaning unit.

15. An electrophotographic apparatus comprising the electrophotographic photosensitive member according to claim 1, a charging unit, an exposure unit, a developing unit and a transferring unit.
